(19) United States
(12) Patent Application Publication
(10) Pub. No.: US 2015/0358562 A1
(43) Pub. Date: Dec. 10, 2015

(54) SOLID-STATE IMAGING DEVICE

(71) Applicant: Kabushiki Kaisha Toshiba, Minato-ku (JP)

(72) Inventor: Yoshitaka EGAWA, Yokohama (JP)

(73) Assignee: Kabushiki Kaisha Toshiba, Minato-ku (JP)

(21) Appl. No.: 14/628,618

(22) Filed: Feb. 23, 2015

(30) Foreign Application Priority Data
Jun. 9, 2014 (JP) 2014-118587

(51) Int. Cl. H04N 5/357; H04N 5/372

(52) U.S. Cl. CPC H04N 5/357; H04N 5/37213

(57) ABSTRACT

According to one embodiment, pixels each in which first and second photoelectric conversion units each of which accumulate charges obtained by photoelectric conversion are arranged to be adjacent in a certain direction are arranged in a row direction and a column direction in a form of a matrix, micro lenses each of which is shared by the first and second photoelectric conversion units, and a read timing is controlled such that a read order of the first photoelectric conversion units and the second photoelectric conversion units in first and second lines of a same color is changed.

### CROSS-REFERENCE TO RELATED APPLICATIONS

This application is based upon and claims the benefit of priority from Japanese Patent Application No. 2014-118587, filed on Jun. 9, 2014; the entire contents of which are incorporated herein by reference.

### FIELD

Embodiments described herein relate generally to a solid-state imaging device.

### BACKGROUND

In solid-state imaging devices, there are cases in which an image plane phase difference pixel is used to perform imaging and focusing on an imaging plane. In the image plane phase difference pixel, one micro lens is disposed for one pixel, and a photoelectric conversion unit of the pixel is divided into two.

### BRIEF DESCRIPTION OF THE DRAWINGS

FIG. 1 is a block diagram illustrating a schematic configuration of a solid-state imaging device according to a first embodiment;

FIG. 2A is a diagram illustrating an exemplary arrangement of a first photoelectric conversion unit and a second photoelectric conversion unit of the solid-state imaging device of FIG. 1, FIG. 2B is a diagram illustrating a read order in a first read operation of the solid-state imaging device of FIG. 1, and FIG. 2C is a diagram illustrating a read order in a second read operation of the solid-state imaging device of FIG. 1;

FIG. 3 is a circuit diagram illustrating an exemplary pixel configuration of 1×4 pixels in a 2-pixel 1-cell configuration of a solid-state imaging device according to a second embodiment;

FIG. 4 is a timing chart illustrating voltage waveforms of respective components when a pixel of FIG. 3 performs a first read operation;

FIG. 5 is a timing chart illustrating voltage waveforms of respective components when the pixel of FIG. 3 performs a second read operation;

FIG. 6 is a timing chart illustrating voltage waveforms of respective components when the pixel of FIG. 3 performs a third read operation;

FIG. 7 is a timing chart illustrating voltage waveforms of respective components when the pixel of FIG. 3 performs a fourth read operation;

FIG. 8 is a timing chart illustrating voltage waveforms of respective components when the pixel of FIG. 3 performs a fifth read operation;

FIG. 9 is a timing chart illustrating voltage waveforms of respective components when the pixel of FIG. 3 performs a sixth read operation;

FIG. 10 is a timing chart illustrating voltage waveforms of respective components when the pixel of FIG. 3 performs a seventh read operation;

FIG. 11 is a circuit diagram illustrating an exemplary pixel configuration of 1×4 pixels in a 2-pixel 1-cell configuration of a solid-state imaging device according to a third embodiment;

FIG. 12 is a circuit diagram illustrating an exemplary pixel configuration of 1×4 pixels in a 2-pixel 1-cell configuration of a solid-state imaging device according to a fourth embodiment;

FIG. 13 is a timing chart illustrating voltage waveforms of respective components when a pixel of FIG. 12 performs a first read operation;

FIG. 14 is a timing chart illustrating voltage waveforms of respective components when the pixel of FIG. 12 performs a second read operation;

FIG. 15 is a timing chart illustrating voltage waveforms of respective components when the pixel of FIG. 12 performs a third read operation;

FIG. 16 is a timing chart illustrating voltage waveforms of respective components when the pixel of FIG. 12 performs a fourth read operation;

FIG. 17 is a timing chart illustrating voltage waveforms of respective components when the pixel of FIG. 12 performs a fifth read operation;

FIG. 18 is a timing chart illustrating voltage waveforms of respective components when the pixel of FIG. 12 performs a sixth read operation;

FIG. 19 is a plane view illustrating an exemplary layout configuration of the pixel of FIG. 12;

FIG. 20 is a circuit diagram illustrating an exemplary pixel configuration of 1×4 pixels in a 2-pixel 1-cell configuration of a solid-state imaging device according to a fifth embodiment;

FIG. 21 is a plane view illustrating an exemplary layout configuration of a pixel of FIG. 20;

FIG. 22 is a block diagram illustrating a schematic configuration of a solid-state imaging device according to a sixth embodiment;

FIG. 23 is a block diagram illustrating a schematic configuration of a digital camera to which a solid-state imaging device according to a seventh embodiment; and

FIG. 24 is a cross-sectional view illustrating a schematic configuration of a camera module to which a solid-state imaging device is applied according to an eighth embodiment.

### DETAILED DESCRIPTION

According to one embodiment, a solid-state imaging device includes a pixel array unit, micro lenses, and a timing control circuit. The pixel array unit includes pixels arranged in a row direction and a column direction, each of the pixels includes first and second photoelectric conversion units that are arranged to be adjacent in a certain direction, and each of the first and second photoelectric conversion units accumulates charges obtained by photoelectric conversion. Each of the micro lenses is disposed for each pixel. The timing control circuit controls a read timing such that a read order of the first photoelectric conversion units and the second photoelectric conversion units in first and second lines of a same color is changed.

Hereinafter, exemplary embodiments of a solid-state imaging device will be described below in detail with reference to the accompanying drawings. The present invention is not limited to the following embodiments.

### First Embodiment

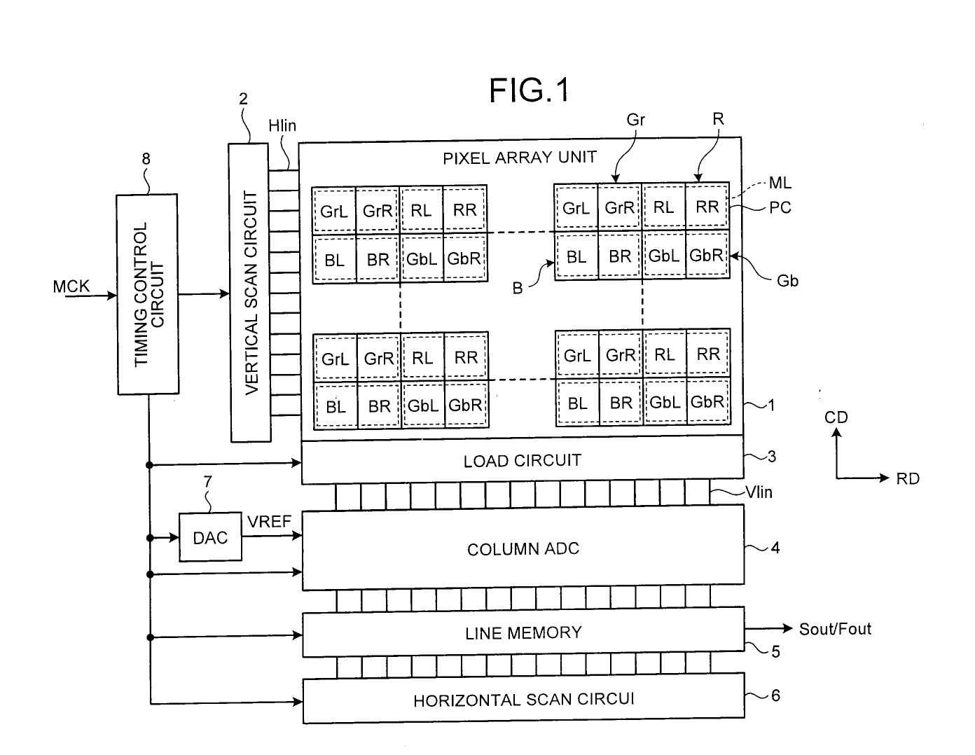

FIG. 1 is a block diagram illustrating a schematic configuration of a solid-state imaging device according to a first embodiment.

Referring to FIG. 1, a solid-state imaging device is provided with a pixel array unit 1. In the pixel array unit 1, pixels PC each of which accumulates charges obtained by photoelectric conversion are arranged in the form of an m×n matrix (m is a positive integer, and n is a positive integer) in which m pixels are arranged in a row direction RD, and n pixels are arranged in a column direction CD. In the pixel array unit 1, horizontal control lines Hlin used to control reading of the pixels PC are disposed in the row direction RD, and vertical signal lines Vlin used to transfer signals read from the pixels PC are disposed in the column direction CD. The pixel PC may configure the Bayer array including two green pixels Gr and Gb, one red pixel R, and one blue pixel B.

Here, each of the pixels PC is provided with first and second photoelectric conversion units arranged to be adjacent in the row direction RD. A photo diode may be used as a photoelectric conversion unit. For example, in the Bayer array, photoelectric conversion units GrL and GrR are disposed for a green pixel Gr, photoelectric conversion units RL and RR are disposed for a red pixel R, photoelectric conversion units BL and BR are disposed for a blue pixel B, and photoelectric conversion units GbL and GbR are disposed for a green pixel Gb. Each of the pixels PC is further provided with a micro lens ML that is shared by the first photoelectric conversion unit and the second photoelectric conversion unit.

The solid-state imaging device is further provided with a vertical scan circuit 2 that scans the pixels PC of the reading target in the vertical direction, a load circuit 3 that performs a source follower operation with the pixels PC and reads pixel signals from the pixels PC to the vertical signal line Vlin in units of columns, a column ADC circuit 4 that performs a CDS process for extracting only signal components of the pixels PC and performs conversion into a digital signal, a line memory 5 that stores the signal components of the pixels PC detected by the column ADC circuit 4 in units of columns, a horizontal scan circuit 6 that scans the pixels PC of the reading target in the horizontal direction, a reference voltage generating circuit 7 that outputs a reference voltage VREF to the column ADC circuit 4, and a timing control circuit 8 that controls reading timings and accumulation timings of the pixels PC. A master clock MCK is input to the timing control circuit 8. A ramp wave may be used as the reference voltage VREF. Here, the timing control circuit 8 can control a read timing such that a read order of the first photoelectric conversion unit and the second photoelectric conversion unit of the pixels PC in a first line is different from a read order of those in a second line of the same color pixels as the first line.

Then, at the time of imaging, the vertical scan circuit 2 scans the pixels PC in the vertical direction in units of lines, and thus the pixels PC are selected in the row direction RD. At this time, signals of the first photoelectric conversion unit and the second photoelectric conversion unit of each pixel PC are simultaneously read. The load circuit 3 performs the source follower operation with the pixels PC in units of columns, and thus the pixel signals read from the pixels PC are transferred to the column ADC circuit 4 via the vertical signal line Vlin. In the reference voltage generating circuit 7, the ramp wave is set as the reference voltage VREF and transferred to the column ADC circuit 4. The column ADC circuit 4 performs conversion into a digital signal by performing a clock count operation until a signal level and a reset level read from the pixel PC match levels of the ramp wave. At this time, a difference between the signal level and the reset level is obtained, and thus the signal component of each pixel PC is detected through the CDS and output via the line memory 5 as the output signal Sout.

Meanwhile, at the time of focusing, the vertical scan circuit 2 scans the pixels PC in units of lines in the vertical direction, and thus the pixels PC are selected in the row direction RD. At this time, signals of the first photoelectric conversion units and the second photoelectric conversion units of the pixels PC are separately read in units of lines. The load circuit 3 performs the source follower operation with the first photoelectric conversion units and the second photoelectric conversion units of the pixels PC in units of columns, and thus the pixel signals read from the first photoelectric conversion units and the second photoelectric conversion units of the pixels PC are transferred to the column ADC circuit 4 via the vertical signal lines Vlin. In the reference voltage generating circuit 7, the ramp wave is set as the reference voltage VREF and transferred to the column ADC circuit 4. The column ADC circuit 4 performs conversion into a digital signal by performing a clock count operation until a signal level and a reset level read from the first photoelectric conversion unit and the second photoelectric conversion unit of the pixel PC match levels of the ramp wave. At this time, as a difference between the signal level and the reset level is obtained, the signal component of the first photoelectric conversion unit and the second photoelectric conversion unit of each pixel PC is detected through the CDS and output via the line memory 5 as the output signal Fout.

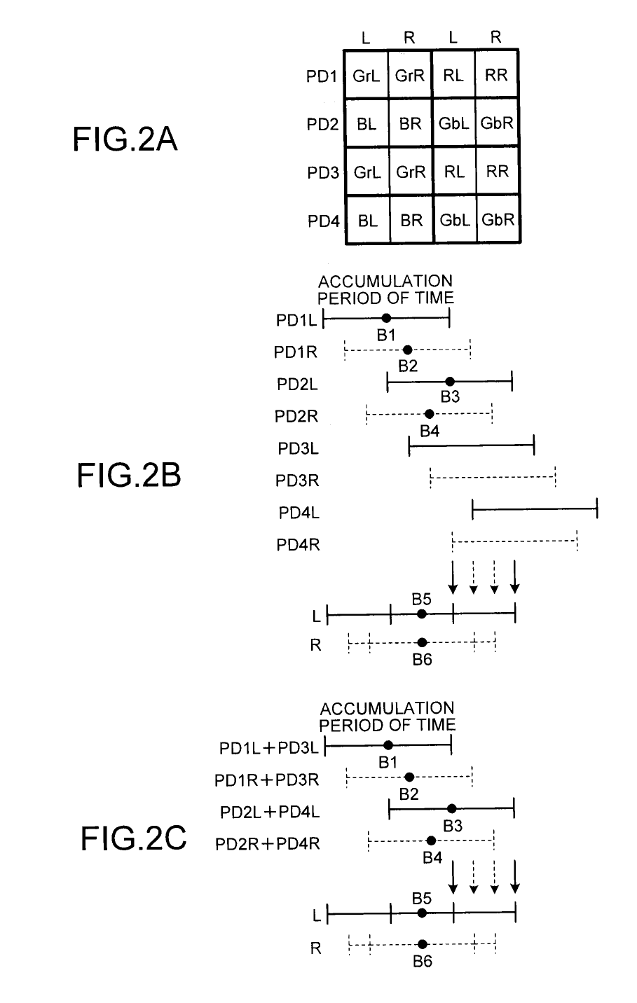

FIG. 2A is a diagram illustrating an exemplary arrangement of the first photoelectric conversion unit and the second photoelectric conversion unit of the solid-state imaging device of FIG. 1, FIG. 2B is a diagram illustrating a read order in a first read operation of the solid-state imaging device of FIG. 1, and FIG. 2C is a diagram illustrating a read order in a second read operation of the solid-state imaging device of FIG. 1. The first read operation indicates an operation when no binning operation is performed at the time of focusing, and the second read operation indicates an operation when a binning operation is performed at the time of focusing.

In FIG. 2A, photoelectric conversion units of first to fourth lines of the pixel array unit 1 of FIG. 1 are denoted by PD1 to PD4, a first photoelectric conversion unit of each pixel PC is denoted by L, and a second photoelectric conversion unit of each pixel PC is denoted by R.

In FIG. 2B, at the time of focusing, signals of the first photoelectric conversion unit and the second photoelectric conversion unit of each pixel PC are separately read in units of lines. Thus, even in the case of the pixels PC of the same line, positions of centers of gravity B1 to B4 of accumulation periods of time of the first photoelectric conversion unit and the second photoelectric conversion unit are different. Here, since focusing is performed by comparing signals of the first photoelectric conversion unit and the second photoelectric conversion unit of the same pixels PC when the same subject is imaged, when the subject is moving, if the positions of the centers of gravity B1 to B4 of the accumulation period of time are different, a focusing accuracy is lowered.

Thus, at the time of the first read operation, for example, the read order of the first photoelectric conversion units and the second photoelectric conversion units of the first line and the second line is reversed, and signals are read in the order of PD1L→PD1R→PD2R PD2L. In other words, the read order of the first photoelectric conversion units and the second photoelectric conversion units of the first line and the second line is reversed, and signals are read in the order of PD1L→PD1R→PD2R→PD2L. Then, signals of the first photoelectric conversion units PD1L and PD2L of the first line and the second line are added, and so the center of gravity of the accumulation period of time is set to B5, and signals of the second photoelectric conversion units PD1R and PD2R of the first line and the second line are added, and so the center of gravity of the accumulation period of time is set to B6. As a result, it is possible to cause the center of gravity B5 of the accumulation period of time of the first photoelectric conversion unit L to match the center of gravity B6 of the accumulation period of time of the second photoelectric conversion unit R, and it is possible to suppress a reduction in the focusing accuracy even when the subject is moving.

When the binning operation is performed at the time of focusing, signals of the first photoelectric conversion unit and the second photoelectric conversion unit of each pixel PC are separately read, and signals of neighboring lines are added for each same color pixel. Even in this case, positions of the centers of gravity B1 to B4 of the accumulation periods of time of the first photoelectric conversion unit and the second photoelectric conversion unit are different.

Thus, at the time of the second read operation, for example, the read order of the first photoelectric conversion units and the second photoelectric conversion units is reversed by simultaneously reading of the first line and the third line and simultaneous reading of the second line and the fourth line, and signals are read in the order of PD1L+PD3L→PD1R+PD3R→PD2R+PD4R→PD2L+PD4L. Then, signals of the first photoelectric conversion units PD1L to PD4L of the first to fourth lines are added, and so the center of gravity of the accumulation period of time is set to B5, and signals of the second photoelectric conversion units PD1R to PD4R of the first to fourth lines are added, and so the center of gravity of the accumulation period of time is set to B6. As a result, it is possible to cause the center of gravity B5 of the accumulation period of time of the first photoelectric conversion unit L to match the center of gravity B6 of the accumulation period of time of the second photoelectric conversion unit R, and it is possible to suppress a reduction in the focusing accuracy even when the subject is moving.

### Second Embodiment

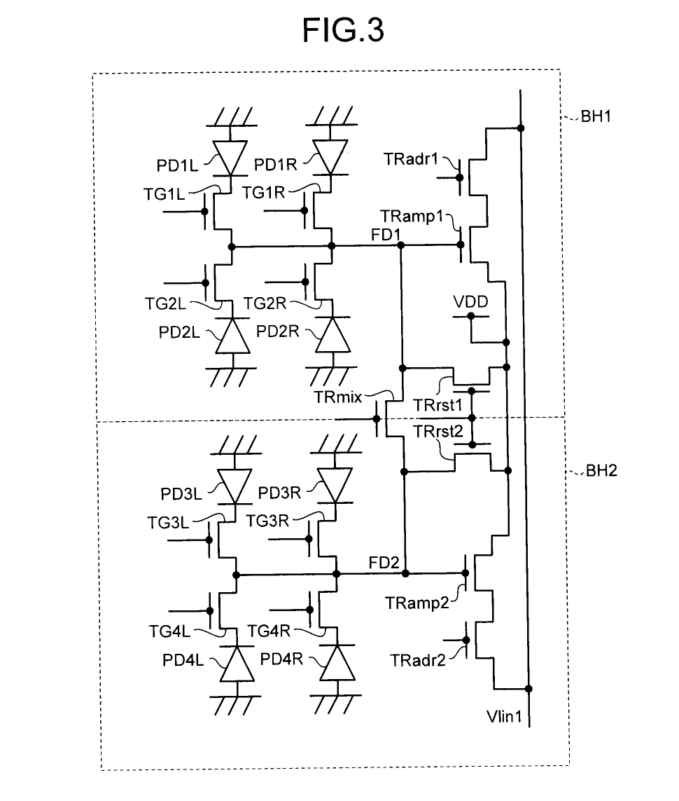

FIG. 3 is a circuit diagram illustrating an exemplary pixel configuration of 1×4 pixels in a 2-pixel 1-cell configuration of a solid-state imaging device according to a second embodiment. In the example of FIG. 3, the green pixel Gr and the blue pixel B of the Bayer array are selectively illustrated.

Referring to FIG. 3, in the solid-state imaging device, a switching transistor TRmix that causes the pixels PC to perform the binning operation is disposed between 2-pixel 1-cell configurations. The switching transistor TRmix may be disposed between the 2-pixel 1-cell configurations neighboring in the column direction CD. A pixel configuration in which a voltage converting unit that converts charges accumulated in the pixels PC into a voltage is shared by a plurality of pixels PC, and an amplifying transistor that amplifies the voltage converted by the voltage converting unit is provided is called a cell, the switching transistor TRmix may be disposed between cells.

For example, in a still image mode, it is possible to individually read signals from the pixels PC by turning off the switching transistor TRmix. For example, in a moving image mode or a monitor mode, it is possible to cause the pixel PC to perform the binning operation by turning on the switching transistor TRmix. All the switching transistors TRmix may be simultaneously controlled, or the switching transistors TRmix may be controlled in units of the horizontal control lines Hlin in synchronization with the vertical scan circuit 2.

Here, when the switching transistor TRmix is turned off, it is possible to reduce the capacity of the voltage converting unit that converts charges accumulated in the pixel PC into a voltage to be smaller than when the switching transistor TRmix is turned on. Thus, when the pixels PC are caused not to perform the binning operation, it is possible to increase the conversion gain and improve an SN ratio compared to when the pixels PC are caused to perform the binning operation. The switching transistor TRmix may function as a conversion capacity switching unit that changes the conversion capacity of the voltage converting unit.

Meanwhile, when the pixels PC are caused to perform the binning operation, it is possible to read signals from the pixels PC in units of 2 lines, and it is possible to double the read speed. Further, it is possible to perform the source follower operation of causing the amplifying transistors TRamp1 and TRamp2 to operate in parallel with the pixels PC of the two lines, and it is possible to reduce the noise of the pixel signal transferred via the vertical signal line Vlin to 1/√2.

Next, a connection elation of the switching transistor TRmix will be specifically described. Here, Bayer arrays BH1 and BH2 are assumed to be arranged to be adjacent in the column direction CD. In the Bayer array BH1, a first photoelectric conversion unit PD1L and a second photoelectric conversion unit PD1R are disposed for the green pixel Gr, and a first photoelectric conversion unit PD2L and a second photoelectric conversion unit PD2R are disposed for the blue pixel B. In the Bayer array BH1, a row selecting transistor TRadr1, an amplifying transistor TRamp1, a reset transistor TRrst1, and read transistors TG1L, TG1R, TG2L, and TG2R are disposed. A floating diffusion FD1 is formed at a connection point of the amplifying transistor TRamp1, the reset transistor TRrst1, and the read transistors TG1L, TG1R, TG2L, and TG2R as a voltage converting unit.

Then, the photoelectric conversion unit PD1L is connected to the floating diffusion FD1 via the read transistor TG1L, the photoelectric conversion unit PD1R is connected to the floating diffusion FD1 via the read transistor TG1R, the photoelectric conversion unit PD2L is connected to the floating diffusion FD1 via the read transistor TG2L, and the photoelectric conversion unit PD2R is connected to the floating diffusion FD1 via the read transistor TG2R. A gate of the amplifying transistor TRamp1 is connected to the floating diffusion FD1, a source of the amplifying transistor TRamp1 is connected to the vertical signal line Vlin1 via the row selecting transistor TRadr1, and a drain of the amplifying transistor TRamp1 is connected to the power potential VDD. The floating diffusion FD1 is connected to the power potential VDD via the reset transistor TRrst1.

In the Bayer array BH2, a first photoelectric conversion unit PD3L and a second photoelectric conversion unit PD3R are disposed for the green pixel Gr, and a first photoelectric conversion unit PD4L and a second photoelectric conversion unit PD4R are disposed for the blue pixel B. Further, in the Bayer array BH2, a row selecting transistor TRadr2, an amplifying transistor TRamp2, a reset transistor TRrst2, and read transistors TG3L, TG3R, TG4L, and TG4R are disposed. A floating diffusion FD2 is formed at a connection point of the amplifying transistor TRamp2, the reset transistor TRrst2, and the read transistors TG3L, TG3R, TG4L, and TG4R as a voltage converting unit.

The photoelectric conversion unit PD3L is connected to the floating diffusion FD2 via the read transistor TG3L, the photoelectric conversion unit PD3R is connected to the floating diffusion FD2 via the read transistor TG3R, the photoelectric conversion unit PD4L is connected to the floating diffusion FD2 via the read transistor TG4L, and the photoelectric conversion unit PD4R is connected to the floating diffusion FD2 via the read transistor TG4R. A gate of the amplifying transistor TRamp2 is connected to the floating diffusion FD2, a source of the amplifying transistor TRamp2 is connected to the vertical signal line Vlin1 via the row selecting transistor TRadr2, and a drain of the amplifying transistor TRamp2 is connected to the power potential VDD. The floating diffusion FD2 is connected to the power potential VDD via the reset transistor TRrst2.

Further, signals can be input to the gates of the row selecting transistors TRadr1 and TRadr2, the reset transistors TRrst1 and TRrst2, and the read transistors TG1L, TG1R, TG2L, TG2R, TG3L, TG3R, TG4L, and TG4R via the horizontal control line Hlin. The floating diffusions FD1 and FD2 are connected to each other via the switching transistor TRmix.

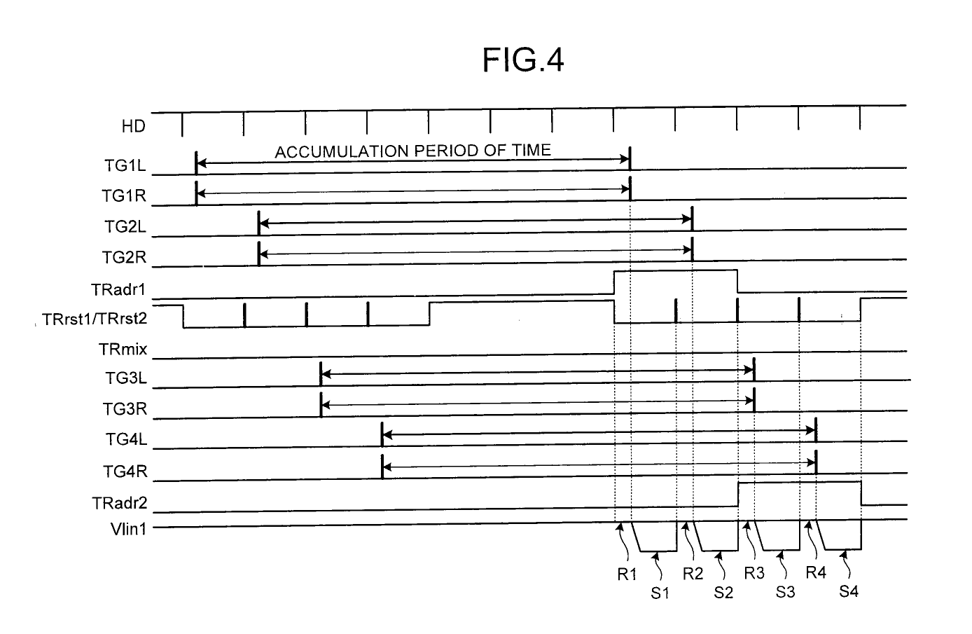

FIG. 4 is a timing chart illustrating voltage waveforms of the respective components when the pixel of FIG. 3 performs a first read operation.

Referring to FIG. 4, in the first read operation, as the switching transistor TRmix is turned off, the capacities of the floating diffusions FD1 and FD2 are separated from each other.

Then, as the read transistors TG1L and TG1R are simultaneously turned on, the residual charges of the photoelectric conversion units PD1L and PD1R are discharged to the floating diffusion FD1. Thereafter, as the read transistors TG1L and TG1R are simultaneously turned off, an operation of accumulating the signal charges in the photoelectric conversion units PD1L and PD1R starts. Then, as the reset transistors TRrst1 and TRrst2 are turned on, the charges of the floating diffusion FD1 are discharged, and then the reset transistors TRrst1 and TRrst2 are turned off.

After the reset transistors TRrst1 and TRrst2 are turned off, as the read transistor TG2L, TG2R are simultaneously turned on, the residual charges of the photoelectric conversion unit PD2L, PD2R are discharged to the floating diffusion FD1. Thereafter, as the read transistors TG2L and TG2R are simultaneously turned off, an operation of accumulating the signal charges in the photoelectric conversion units PD2L and PD2R starts. Then, as the reset transistors TRrst1 and TRrst2 are turned on, the charges of the floating diffusion FD1 are discharged, and then the reset transistors TRrst1 and TRrst2 are turned off.

After the reset transistors TRrst1 and TRrst2 are turned off, as the read transistor TG3L, TG3R are simultaneously turned on, the residual charges of the photoelectric conversion units PD3L and PD3R are discharged to the floating diffusion FD2. Thereafter, as the read transistors TG3L and TG3R are simultaneously turned off, an operation of accumulating the signal charges in the photoelectric conversion units PD3L and PD3R starts. Then, as the reset transistors TRrst1 and TRrst2 are turned on, the charges of the floating diffusion FD2 are discharged, and then the reset transistors TRrst1 and TRrst2 are turned off.

After the reset transistors TRrst1 and TRrst2 are turned off, as the read transistor TG4L, TG4R are simultaneously turned on, the residual charges of the photoelectric conversion units PD4L and PD4R are discharged to the floating diffusion FD2. Thereafter, as the read transistors TG4L and TG4R are simultaneously turned off, an operation of accumulating the signal charges in the photoelectric conversion units PD4L and PD4R starts. Then, as the reset transistors TRrst1 and TRrst2 are turned on, the charges of the floating diffusion FD2 are discharged, and then the reset transistors TRrst1 and TRrst2 are turned off.

Then, as the row selecting transistor TRadr1 is turned on when the read transistors TG1L and TG1R, TG2L, TG2R are in the off state, the amplifying transistor TRamp1 performs the source follower operation, and thus a voltage according to the charges of the black level of the floating diffusion FD1 is read out to the vertical signal line Vlin1. Then, a pixel signal R1 of the black level is detected based on the voltage of the vertical signal line Vlin1 at this time. Thereafter, as the read transistors TG1L and TG1R are simultaneously turned on, the signal charges of the photoelectric conversion units PD1L and PD1R are read out to the floating diffusion FD1. Then, the amplifying transistor TRamp1 performs the source follower operation, and thus a voltage according to the charges of the signal level of the floating diffusion FD1 is read out to the vertical signal line Vlin1. Then, a pixel signal S1 of the signal level is detected based on the voltage of the vertical signal line Vlin1 at this time. Then, a difference between the pixel signal S1 of the signal level and the pixel signal R1 of the black level is obtained, and thus a signal component according to the charges accumulated in the photoelectric conversion units PD1L and PD1R is detected.

After the pixel signal S1 of the signal level is output to the vertical signal line Vlin1, as the reset transistor TRrst1 is turned on, the charges of the floating diffusion FD1 are discharged. Then, if the row selecting transistor TRadr1 is turned on when the read transistors TG1L, TG1R, TG2L, and TG2R are in the off state, the amplifying transistor TRamp1 performs the source follower operation, and thus a voltage according to the charges of the black level of the floating diffusion FD1 is read out to the vertical signal line Vlin1. Then, a pixel signal R2 of the black level is detected based on the voltage of the vertical signal line Vlin1 at this time. Thereafter, as the read transistors TG2L and TG2R are simultaneously turned on, the signal charges of the photoelectric conversion units PD2L and PD2R are read out to the floating diffusion FD1. Then, the amplifying transistor TRamp1 performs the source follower operation, and thus a voltage according to the charges of the signal level of the floating diffusion FD1 is read out to the vertical signal line Vlin1. Then, a pixel signal S2 of the signal level is detected based on the voltage of the vertical signal line Vlin1 at this time. Then, a difference between the pixel signal S2 of the signal level and the pixel signal R2 of the black level is obtained, and thus a signal component according to the charges accumulated in the photoelectric conversion units PD2L and PD2R is detected.

After the pixel signal S2 of the signal level is output to the vertical signal line Vlin1, as the reset transistor TRrst2 is turned on, the charges of the floating diffusion FD2 are discharged. Then, if the row selecting transistor TRadr2 is turned on when the read transistors TG3L, TG3R, TG4L, and TG4R are in the off state, the amplifying transistor TRamp2 performs the source follower operation, and thus a voltage according to the charges of the black level of the floating diffusion FD2 is read out to the vertical signal line Vlin1. Then, the pixel signal R3 of the black level is detected based on the voltage of the vertical signal line Vlin1 at this time. Thereafter, as the read transistors TG3L and TG3R are simultaneously turned on, the signal charges of the photoelectric conversion units PD3L and PD3R are read out to the floating diffusion FD2. Then, the amplifying transistor TRamp2 performs the source follower operation, and thus a voltage according to the charges of the signal level of the floating diffusion FD2 is read out to the vertical signal line Vlin1. Then, a pixel signal S3 of the signal level is detected based on the voltage of the vertical signal line Vlin1 at this time. Then, a difference between the pixel signal S3 of the signal level and the pixel signal R3 of the black level is obtained, and thus a signal component according to the charges accumulated in the photoelectric conversion units PD3L and PD3R is detected.

After the pixel signal S3 of the signal level is output to the vertical signal line Vlin1, as the reset transistor TRrst2 is turned on, the charges of the floating diffusion FD2 are discharged. Then, if the row selecting transistor TRadr2 is turned on when the read transistors TG3L, TG3R, TG4L, and TG4R are in the off state, the amplifying transistor TRamp2 performs the source follower operation, and thus a voltage according to the charges of the black level of the floating diffusion FD2 is read out to the vertical signal line Vlin1. Then, a pixel signal R4 of the black level is detected based on the voltage of the vertical signal line Vlin1 at this time. Thereafter, as the read transistors TG4L and TG4R are simultaneously turned on, the signal charges of the photoelectric conversion units PD4L and PD4R are read out to the floating diffusion FD2. Then, as the amplifying transistor TRamp2 performs the source follower operation, and thus a voltage according to the charges of the signal level of the floating diffusion FD2 is read out to the vertical signal line Vlin1. Then, a pixel signal S4 of the signal level is detected based on the voltage of the vertical signal line Vlin1 at this time. Then, a difference between the pixel signal S4 of the signal level and the pixel signal R4 of the black level is obtained, and thus a signal component according to the charges accumulated in the photoelectric conversion units PD4L and PD4R is detected.

Here, in the first read operation, it is possible to separate the capacities of the floating diffusions FD1 and FD2 through the switching transistor TRmix, and thus it is possible to reduce the capacity of the voltage converting unit that converts charges accumulated in the pixel PC into a voltage. Accordingly, it is possible to increase the conversion gain of the voltage converting unit and improve an SN ratio at the time of imaging.

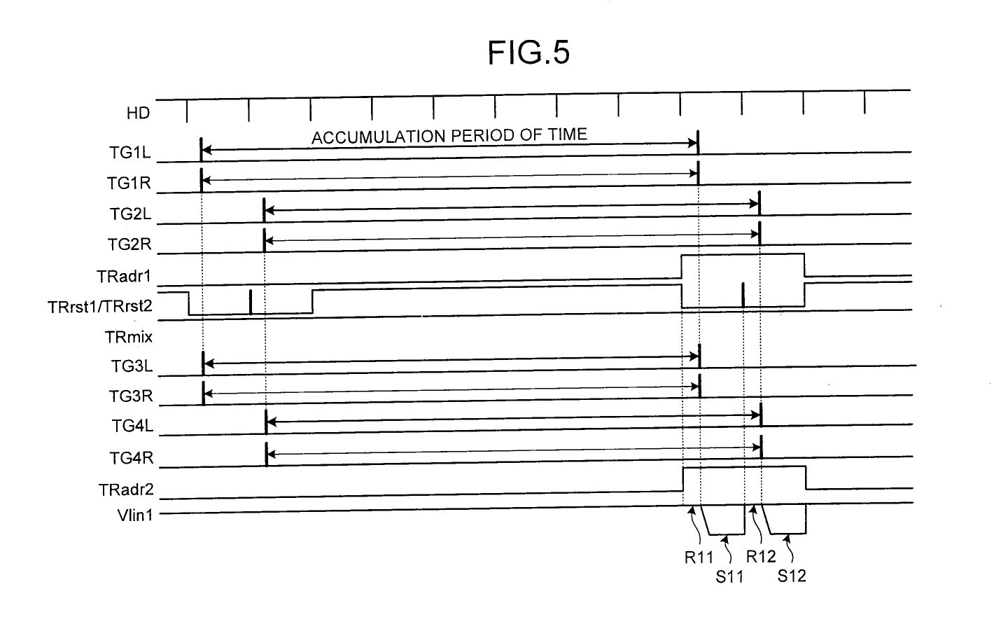

FIG. 5 is a timing chart illustrating voltage waveforms of the respective components when the pixel of FIG. 3 performs a second read operation.

Referring to FIG. 5, in the second read operation, as the switching transistor TRmix is turned on, the capacities of the floating diffusions FD1 and FD2 are combined.

Then, as the read transistors TG1L, TG1R, TG3L, and TG3R are simultaneously turned on, the residual charges of the photoelectric conversion units PD1L, PD1R, PD3L, and PD3R are discharged to the floating diffusions FD1 and FD2. Thereafter, as the read transistors TG1L, TG1R, TG3L, and TG3R are simultaneously turned off, an operation of accumulating the signal charges in the photoelectric conversion units PD1L, PD1R, PD3L, and PD3R starts. Then, as the reset transistors TRrst1 and TRrst2 are turned on, the charges of the floating diffusions FD1 and FD2 are discharged, and then the reset transistors TRrst1 and TRrst2 are turned off.

After the reset transistors TRrst1 and TRrst2 are turned off, as the read transistors TG2L, TG2R, TG4L, and TG4R are simultaneously turned on, the residual charges of the photoelectric conversion units PD2L, PD2R, PD4L, and PD4R are discharged to the floating diffusions FD1 and FD2. Thereafter, as the read transistors TG2L, TG2R, TG4L, and TG4R are simultaneously turned off, an operation of accumulating the signal charges in the photoelectric conversion units PD2L, PD2R, PD4L, and PD4R starts. Then, as the reset transistors TRrst1 and TRrst2 are turned on, the charges of the floating diffusions FD1 and FD2 are discharged, and then the reset transistors TRrst1 and TRrst2 are turned off.

Then, if the row selecting transistors TRadr1 and TRadr2 are turned on when the read transistors TG1L, TG1R, TG2L, TG2R, TG3L, TG3R, TG4L, and TG4R are in the off state, the amplifying transistors TRamp1 and TRamp2 perform the source follower operation, and thus a voltage according to the charges of the black level of the floating diffusions FD1 and FD2 is read out to the vertical signal line Vlin1. Then, a pixel signal R11 of the black level is detected based on the voltage of the vertical signal line Vlin1 at this time. Thereafter, as the read transistors TG1L, TG1R, TG3L, and TG3R are simultaneously turned on, the signal charges of the photoelectric conversion units PD1L, PD1R, PD3L, and PD3R are read out to the floating diffusions FD1 and FD2. Then, the amplifying transistors TRamp1 and TRamp2 perform the source follower operation, and thus a voltage according to the charges of the signal level of the floating diffusions FD1 and FD2 is read out to the vertical signal line Vlin1. Then, a pixel signal S11 of the signal level is detected based on the voltage of the vertical signal line Vlin1 at this time. Then, a difference between the pixel signal S11 of the signal level and the pixel signal R11 of the black level is obtained, and thus a signal component according to the charges accumulated in the photoelectric conversion units PD1L, PD1R, PD3L, and PD3R is detected.

After the pixel signal S11 of the signal level is output to the vertical signal line Vlin1, as the reset transistors TRrst1 and TRrst2 are turned on, the charges of the floating diffusions FD1 and FD2 are discharged. Then, if the row selecting transistors TRadr1 and TRadr2 are turned on when the read transistors TG1L, TG1R, TG2L, TG2R, TG3L, TG3R, TG4L, and TG4R are in the off state, the amplifying transistors TRamp1 and TRamp2 perform the source follower operation, and thus a voltage according to the charges of the black level of the floating diffusions FD1 and FD2 is read out to the vertical signal line Vlin1. Then, a pixel signal R12 of the black level is detected based on the voltage of the vertical signal line Vlin1 at this time. Thereafter, as the read transistors TG2L, TG2R, TG4L, and TG4R are simultaneously turned on, the signal charges of the photoelectric conversion units PD2L, PD2R, PD4L, and PD4R are read out to the floating diffusions FD1 and FD2. Then, the amplifying transistors TRamp1 and TRamp2 perform the source follower operation, and thus a voltage according to the charges of the signal level of the floating diffusions FD1 and FD2 is read out to the vertical signal line Vlin1. Then, a pixel signal S12 of the signal level is detected based on the voltage of the vertical signal line Vlin1 at this time. Then, a difference between the pixel signal S12 of the signal level and the pixel signal R12 of the black level is obtained, and thus a signal component according to the charges accumulated in the photoelectric conversion units PD2L, PD2R, PD4L, and PD4R is detected.

Here, in the second read operation, it is possible to combine the capacities of the floating diffusions FD1 and FD2 through the switching transistor TRmix and cause the pixels PC to perform the binning operation at the time of imaging. Accordingly, it is possible to read signals from the pixels PC in units of two lines and thus double the read speed. Further, it is possible to perform the source follower operation of causing the amplifying transistors TRamp1 and TRamp2 to operate in parallel with the pixels PC of the two lines, and it is possible to reduce the noise of the pixel signal transferred via the vertical signal line Vlin1 to 1/√2.

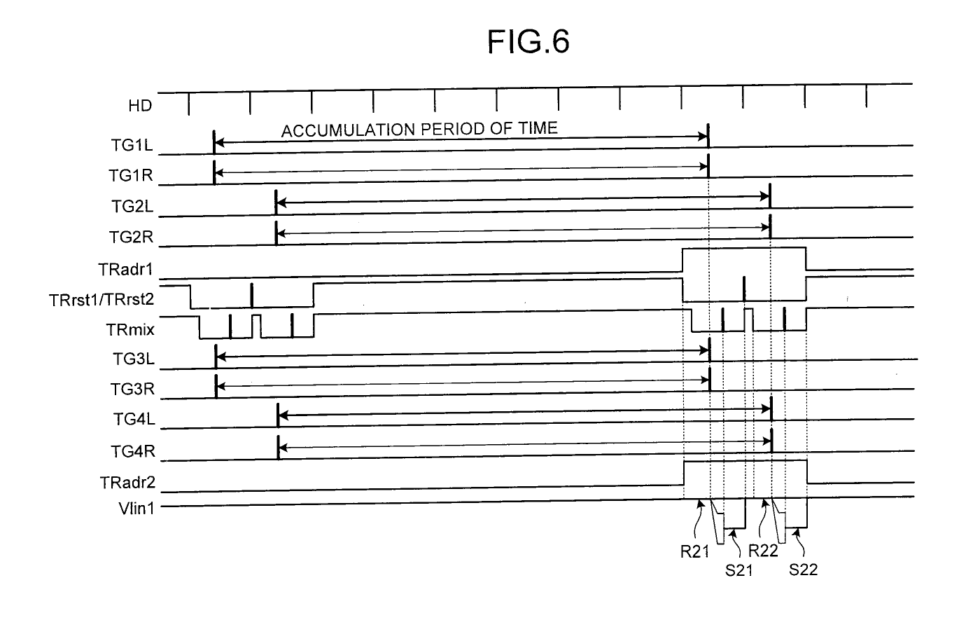

FIG. 6 is a timing chart illustrating voltage waveforms of the respective components when the pixel of FIG. 3 performs a third read operation.

Referring to FIG. 6, as the switching transistor TRmix is turned off, the capacities of the floating diffusions FD1 and FD2 are separated from each other. Then, as the read transistors TG1L, TG1R, TG3L, and TG3R are simultaneously turned on, the residual charges of the photoelectric conversion units PD1L, PD1R, PD3L, and PD3R are discharged to the floating diffusions FD1 and FD2. Thereafter, as the read transistors TG1L, TG1R, TG3L, and TG3R are simultaneously turned off, an operation of accumulating the signal charges in the photoelectric conversion units PD1L, PD1R, TG3L, and TG3R starts. Then, as the reset transistors TRrst1 and TRrst2 are turned on, the charges of the floating diffusions FD1 and FD2 are discharged, and then the reset transistors TRrst1 and TRrst2 are turned off.

After the reset transistors TRrst1 and TRrst2 are turned off, as the read transistors TG2L, TG2R, TG4L, and TG4R are simultaneously turned on, the residual charges of the photoelectric conversion units PD2L, PD2R, PD4L, and PD4R are discharged to the floating diffusions FD1 and FD2. Thereafter, as the read transistors TG2L, TG2R, TG4L, and TG4R are simultaneously turned off, an operation of accumulating the signal charges in the photoelectric conversion units PD2L, PD2R, TG4L, and TG4R starts. Then, as the reset transistors TRrst1 and TRrst2 are turned on, the charges of the floating diffusions FD1 and FD2 are discharged, and then the reset transistors TRrst1 and TRrst2 are turned off.

Then, if the row selecting transistors TRadr1 and TRadr2 are turned on when the read transistors TG1L, TG1R, TG2L, TG2R, TG3L, TG3R, TG4L, and TG4R are in the off state, the amplifying transistors TRamp1 and TRamp2 perform the source follower operation, and thus a voltage according to the charges of the black level of the floating diffusions FD1 and FD2 is read out to the vertical signal line Vlin1. Then, a pixel signal R21 of the black level is detected based on the voltage of the vertical signal line Vlin1 at this time. Thereafter, as the read transistors TG1L, TG1R, TG3L, and TG3R are simultaneously turned on, the signal charges of the photoelectric conversion units PD1L and PD1R are read out to the floating diffusion FD1, and the signal charges of the photoelectric conversion units PD3L and PD3R are read out to the floating diffusion FD2. Thereafter, as the switching transistor TRmix is turned on, the capacities of the floating diffusions FD1 and FD2 are combined, and the signal charges of the photoelectric conversion units PD1L, PD1R, PD3L, and PD3R are averaged. Thereafter, as the switching transistor TRmix is turned off, the capacities of the floating diffusions FD1 and FD2 are separated from each other, and the averaged signal charges of the photoelectric conversion units PD1L, PD1R, PD3L, and PD3R are divided. Then, the amplifying transistors TRamp1 and TRamp2 perform the source follower operation, and thus a voltage according to the charges of the signal level of the floating diffusions FD1 and FD2 is read out to the vertical signal line Vlin1. Then, the pixel signal S21 of the signal level is detected based on the voltage of the vertical signal line Vlin1 at this time. Then, a difference between the pixel signal S21 of the signal level and the pixel signal R21 of the black level is obtained, and thus a signal component according to the charges accumulated in the photoelectric conversion units PD1L, PD1R, PD3L, and PD3R is detected.

After the pixel signal S21 of the signal level is output to the vertical signal line Vlin1, as the reset transistors TRrst1 and TRrst2 are turned on, the charges of the floating diffusions FD1 and FD2 are discharged. Then, if the row selecting transistors TRadr1 and TRadr2 are turned on when the read transistors TG1L, TG1R, TG2L, TG2R, TG3L, TG3R, TG4L, and TG4R are in the off state, the amplifying transistors TRamp1 and TRamp2 perform the source follower operation, and thus a voltage according to the charges of the black level of the floating diffusions FD1 and FD2 is read out to the vertical signal line Vlin1. Then, a pixel signal R22 of the black level is detected based on the voltage of the vertical signal line Vlin1 at this time. Thereafter, as the read transistors TG2L, TG2R, TG4L, and TG4R are simultaneously turned on, the signal charges of the photoelectric conversion units PD2L and PD2R are read out to the floating diffusion FD1, and the signal charges of the photoelectric conversion units PD4L and PD4R are read out to the floating diffusion FD2. Thereafter, as the switching transistor TRmix is turned on, the capacities of the floating diffusions FD1 and FD2 are combined, and the signal charges of the photoelectric conversion units PD2L, PD2R, PD4L, and PD4R are averaged. Thereafter, as the switching transistor TRmix is turned off, the capacities of the floating diffusions FD1 and FD2 are separated from each other, the averaged signal charges of the photoelectric conversion units PD2L, PD2R, PD4L, and PD4R are divided. Then, the amplifying transistors TRamp1 and TRamp2 perform the source follower operation, and thus a voltage according to the charges of the signal level of the floating diffusions FD1 and FD2 is read out to the vertical signal line Vlin1. Then, a pixel signal S22 of the signal level is detected based on the voltage of the vertical signal line Vlin1 at this time. Then, a difference between the pixel signal S22 of the signal level and the pixel signal R22 of the black level is obtained, and thus a signal component according to the charges accumulated in the photoelectric conversion units PD2L, PD2R, PD4L, and PD4R is detected.

Here, in the third read operation, it is possible to cause the amplifying transistors TRamp1 and TRamp2 of the two lines to perform the source follower operations in parallel at the time of imaging, and it is possible to reduce the noise of the pixel signals R21 and R22 of the black level and the pixel signals S21 and S22 of the signal level transferred via the vertical signal line Vlin1 to 1/√2. Further, as the switching transistor TRmix is turned on after signal reading, it is possible to cause the potential of the floating diffusion FD1 to be equivalent to the potential of the floating diffusion FD2, and it is possible to reduce the potential difference between the floating diffusions FD1 and FD2 to about several 10 mV. Thus, even when there is a potential difference of 0.3 V to 0.5 V between the floating diffusions FD1 and FD2 after signal reading at the time of imaging, the signal averaged by the source follower operation can be output to the vertical signal line Vlin1.

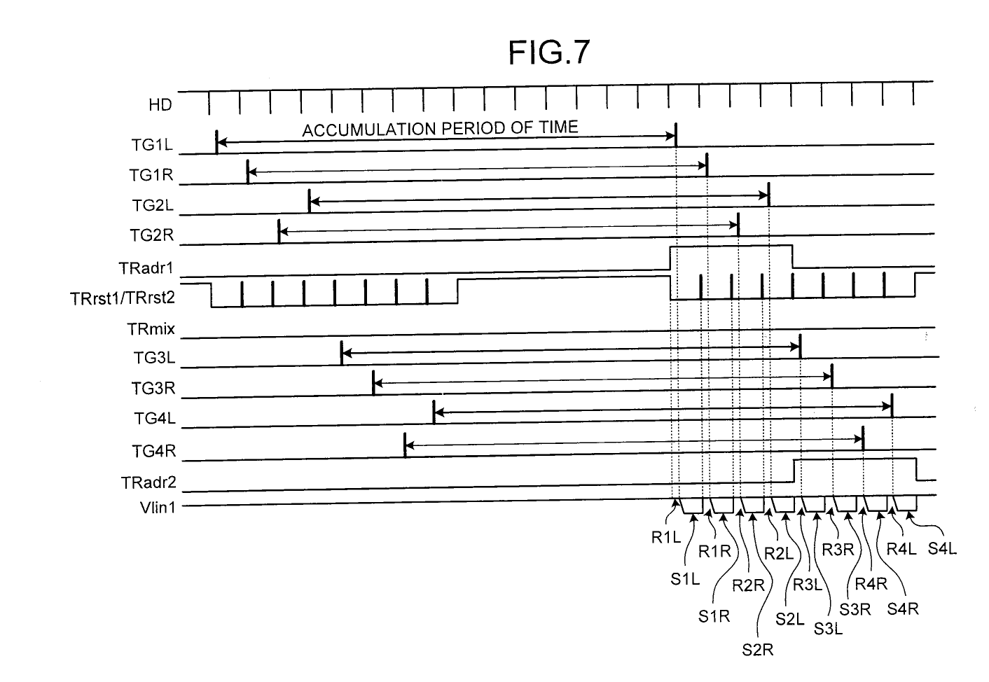

FIG. 7 is a timing chart illustrating voltage waveforms of the respective components when the pixel of FIG. 3 performs a fourth read operation.

Referring to FIG. 7, in the fourth read operation, as the switching transistor TRmix is turned off, the capacities of the floating diffusions FD1 and FD2 are separated from each other.

Then, as the read transistor TG1L is turned on, the residual charges of the photoelectric conversion unit PD1L are discharged to the floating diffusion FD1. Thereafter, as the read transistor TG1L is turned off, an operation of accumulating signal charges in the photoelectric conversion unit PD1L starts. Then, as the reset transistors TRrst1 and TRrst2 are turned on, the charges of the floating diffusion FD1 are discharged, and then the reset transistors TRrst1 and TRrst2 are turned off.

After the reset transistors TRrst1 and TRrst2 are turned off, as the read transistor TG1R is turned on, the residual charges of the photoelectric conversion unit PD1R are discharged to the floating diffusion FD1. Thereafter, as the read transistor TG1R is turned off, an operation of accumulating signal charges in the photoelectric conversion unit PD1R starts. Then, as the reset transistors TRrst1 and TRrst2 are turned on, the charges of the floating diffusion FD1 are discharged, and then the reset transistors TRrst1 and TRrst2 are turned off.

After the reset transistors TRrst1 and TRrst2 are turned off, as the read transistor TG2R is turned on, the residual charges of the photoelectric conversion unit PD2R are discharged to the floating diffusion FD1. Thereafter, as the read transistor TG2R is turned off, an operation of accumulating signal charges in the photoelectric conversion unit PD2R starts. Then, as the reset transistors TRrst1 and TRrst2 are turned on, the charges of the floating diffusion FD1 are discharged, and then the reset transistors TRrst1 and TRrst2 are turned off.

After the reset transistors TRrst1 and TRrst2 are turned off, as the read transistor TG2L is turned on, the residual charges of the photoelectric conversion unit PD2L are discharged to the floating diffusion FD1. Thereafter, as the read transistor TG2L is turned off, an operation of accumulating signal charges in the photoelectric conversion unit PD2L starts. Then, as the reset transistors TRrst1 and TRrst2 are turned on, the charges of the floating diffusion FD1 are discharged, and then the reset transistors TRrst1 and TRrst2 are turned off.

After the reset transistors TRrst1 and TRrst2 are turned off, as the read transistor TG3L is turned on, the residual charges of the photoelectric conversion unit PD3L are discharged to the floating diffusion FD2. Thereafter, as the read transistor TG3L is turned off, an operation of accumulating signal charges in the photoelectric conversion unit PD3L starts. Then, as the reset transistors TRrst1 and TRrst2 are turned on, the charges of the floating diffusion FD2 are discharged, and then the reset transistors TRrst1 and TRrst2 are turned off.

After the reset transistors TRrst1 and TRrst2 are turned off, as the read transistor TG3R is turned on, the residual charges of the photoelectric conversion unit PD3R are discharged to the floating diffusion FD2. Thereafter, as the read transistor TG3R is turned off, an operation of accumulating signal charges in the photoelectric conversion unit PD3R starts. Then, as the reset transistors TRrst1 and TRrst2 are turned on, the charges of the floating diffusion FD2 are discharged, and then the reset transistors TRrst1 and TRrst2 are turned off.

After the reset transistors TRrst1 and TRrst2 are turned off, as the read transistor TG4R is turned on, the residual charges of the photoelectric conversion unit PD4R are discharged to the floating diffusion FD2. Thereafter, as the read transistor TG4R is turned off, an operation of accumulating signal charges in the photoelectric conversion unit PD4R starts. Then, as the reset transistors TRrst1 and TRrst2 are turned on, the charges of the floating diffusion FD2 are discharged, and then the reset transistors TRrst1 and TRrst2 are turned off.

After the reset transistors TRrst1 and TRrst2 are turned off, as the read transistor TG4L is turned on, the residual charges of the photoelectric conversion unit PD4L are discharged to the floating diffusion FD2. Thereafter, as the read transistor TG4L is turned off, an operation of accumulating signal charges in the photoelectric conversion unit PD4L starts. Then, as the reset transistors TRrst1 and TRrst2 are turned on, the charges of the floating diffusion FD2 are discharged, and then the reset transistors TRrst1 and TRrst2 are turned off.

Then, if the row selecting transistor TRadr1 is turned on when the read transistors TG1L, TG1R, TG2L, and TG2R are in the off state, the amplifying transistor TRamp1 performs the source follower operation, and thus a voltage according to the charges of the black level of the floating diffusion FD1 is read out to the vertical signal line Vlin1. Then, a pixel signal R1L of the black level is detected based on the voltage of the vertical signal line Vlin1 at this time. Thereafter, as the read transistor TG1L is turned on, the signal charges of the photoelectric conversion unit PD1L are read out to the floating diffusion FD1. Then, the amplifying transistor TRamp1 performs the source follower operation, and thus a voltage according to the charges of the signal level of the floating diffusion FD1 is read out to the vertical signal line Vlin1. Then, a pixel signal S1L of the signal level is detected based on the voltage of the vertical signal line Vlin1 at this time. Then, a difference between the pixel signal S1L of the signal level and the pixel signal R1L of the black level is obtained, and thus a signal component according to the charges accumulated in the photoelectric conversion unit PD1L is detected.

After the pixel signal S1L of the signal level is output to the vertical signal line Vlin1, as the reset transistor TRrst1 is turned on, the charges of the floating diffusion FD1 are discharged. Then, if the row selecting transistor TRadr1 is turned on when the read transistors TG1L, TG1R, TG2L, and TG2R are in the off state, the amplifying transistor TRamp1 performs the source follower operation, and thus a voltage according to the charges of the black level of the floating diffusion FD1 is read out to the vertical signal line Vlin1. Then, a pixel signal R1R of the black level is detected based on the voltage of the vertical signal line Vlin1 at this time. Thereafter, as the read transistor TG1R is turned on, the signal charges of the photoelectric conversion unit PD1R are read out to the floating diffusion FD1. Then, the amplifying transistor TRamp1 performs the source follower operation, and thus a voltage according to the charges of the signal level of the floating diffusion FD1 is read out to the vertical signal line Vlin1. Then, a pixel signal S1R of the signal level is detected based on the voltage of the vertical signal line Vlin1 at this time. Then, a difference between the pixel signal S1R of the signal level and the pixel signal R1R of the black level is obtained, and thus a signal component according to the charges accumulated in the photoelectric conversion unit PD1R is detected.

After the pixel signal S1R of the signal level is output to the vertical signal line Vlin1, as the reset transistor TRrst1 is turned on, the charges of the floating diffusion FD1 are discharged. Then, if the row selecting transistor TRadr1 is turned on when the read transistors TG1L, TG1R, TG2L, and TG2R are in the off state, the amplifying transistor TRamp1 performs the source follower operation, and thus a voltage according to the charges of the black level of the floating diffusion FD1 is read out to the vertical signal line Vlin1. Then, a pixel signal R2R of the black level is detected based on the voltage of the vertical signal line Vlin1 at this time. Thereafter, as the read transistor TG2R is turned on, the signal charges of the photoelectric conversion unit PD2R are read out to the floating diffusion FD1. Then, the amplifying transistor TRamp1 performs the source follower operation, and thus a voltage according to the charges of the signal level of the floating diffusion FD1 is read out to the vertical signal line Vlin1. Then, a pixel signal S2R of the signal level is detected based on the voltage of the vertical signal line Vlin1 at this time. Then, a difference between the pixel signal S2R of the signal level and the pixel signal R2R of the black level is obtained, and thus a signal component according to the charges accumulated in the photoelectric conversion unit PD2R is detected.

After the pixel signal S2R of the signal level is output to the vertical signal line Vlin1, as the reset transistor TRrst1 is turned on, the charges of the floating diffusion FD1 are discharged. Then, if the row selecting transistor TRadr1 is turned on when the read transistors TG1L, TG1R, TG2L, and TG2R are in the off state, the amplifying transistor TRamp1 performs the source follower operation, and thus a voltage according to the charges of the black level of the floating diffusion FD1 is read out to the vertical signal line Vlin1. Then, a pixel signal R2L of the black level is detected based on the voltage of the vertical signal line Vlin1 at this time. Thereafter, as the read transistor TG2L is turned on, the signal charges of the photoelectric conversion unit PD2L are read out to the floating diffusion FD1. Then, the amplifying transistor TRamp1 performs the source follower operation, and thus a voltage according to the charges of the signal level of the floating diffusion FD1 is read out to the vertical signal line Vlin1. Then, the pixel signal S2L of the signal level is detected based on the voltage of the vertical signal line Vlin1 at this time. Then, a difference between the pixel signal S2L of the signal level and the pixel signal R2L of the black level is obtained, and thus a signal component according to the charges accumulated in the photoelectric conversion unit PD2L is detected.

Then, if the row selecting transistor TRadr2 is turned on when the read transistors TG3L, TG3R, TG4L, and TG4R are in the off state, the amplifying transistor TRamp2 performs the source follower operation, and thus a voltage according to the charges of the black level of the floating diffusion FD2 is read out to the vertical signal line Vlin1. Then, a pixel signal R3L of the black level is detected based on the voltage of the vertical signal line Vlin1 at this time. Thereafter, as the read transistor TG3L is turned on, the signal charges of the photoelectric conversion unit PD3L are read out to the floating diffusion FD2. Then, as the amplifying transistor TRamp2 performs the source follower operation, and thus a voltage according to the charges of the signal level of the floating diffusion FD2 is read out to the vertical signal line Vlin1. Then, a pixel signal S3L of the signal level is detected based on the voltage of the vertical signal line Vlin1 at this time. Then, a difference between the pixel signal S3L of the signal level and the pixel signal R3L of the black level is obtained, and thus a signal component according to the charges accumulated in the photoelectric conversion unit PD3L is detected.

After the pixel signal S3L of the signal level is output to the vertical signal line Vlin1, as the reset transistor TRrst2 is turned on, the charges of the floating diffusion FD2 are discharged. Then, if the row selecting transistor TRadr2 is turned on when the read transistors TG3L, TG3R, TG4L, and TG4R are in the off state, the amplifying transistor TRamp2 performs the source follower operation, and thus a voltage according to the charges of the black level of the floating diffusion FD2 is read out to the vertical signal line Vlin1. Then, a pixel signal R3R of the black level is detected based on the voltage of the vertical signal line Vlin1 at this time. Thereafter, as the read transistor TG3R is turned on, the signal charges of the photoelectric conversion unit PD3R are read out to the floating diffusion FD2. Then, as the amplifying transistor TRamp2 performs the source follower operation, and thus a voltage according to the charges of the signal level of the floating diffusion FD2 is read out to the vertical signal line Vlin1. Then, the pixel signal S3R of the signal level is detected based on the voltage of the vertical signal line Vlin1 at this time. Then, a difference between the pixel signal S3R of the signal level and the pixel signal R3R of the black level is obtained, and thus a signal component according to the charges accumulated in the photoelectric conversion unit PD3R is detected.

After the pixel signal S3R of the signal level is output to the vertical signal line Vlin1, as the reset transistor TRrst2 is turned on, the charges of the floating diffusion FD2 are discharged. Then, if the row selecting transistor TRadr2 is turned on when the read transistors TG3L, TG3R, TG4L, and TG4R are in the off state, the amplifying transistor TRamp2 performs the source follower operation, and thus a voltage according to the charges of the black level of the floating diffusion FD2 is read out to the vertical signal line Vlin1. Then, the pixel signal R4R of the black level is detected based on the voltage of the vertical signal line Vlin1 at this time. Thereafter, as the read transistor TG4R is turned on, the signal charges of the photoelectric conversion unit PD4R are read out to the floating diffusion FD2. Then, as the amplifying transistor TRamp2 performs the source follower operation, and thus a voltage according to the charges of the signal level of the floating diffusion FD2 is read out to the vertical signal line Vlin1. Then, a pixel signal S4R of the signal level is detected based on the voltage of the vertical signal line Vlin1 at this time. Then, a difference between the pixel signal S4R of the signal level and the pixel signal R4R of the black level is obtained, and thus a signal component according to the charges accumulated in the photoelectric conversion unit PD4R is detected.

After the pixel signal S4R of the signal level is output to the vertical signal line Vlin1, as the reset transistor TRrst2 is turned on, the charges of the floating diffusion FD2 are discharged. Then, if the row selecting transistor TRadr2 is turned on when the read transistors TG3L, TG3R, TG4L, and TG4R are in the off state, the amplifying transistor TRamp2 performs the source follower operation, and thus a voltage according to the charges of the black level of the floating diffusion FD2 is read out to the vertical signal line Vlin1. Then, a pixel signal R4L of the black level is detected based on the voltage of the vertical signal line Vlin1 at this time. Thereafter, as the read transistor TG4L is turned on, the signal charges of the photoelectric conversion unit PD4L are read out to the floating diffusion FD2. Then, as the amplifying transistor TRamp2 performs the source follower operation, and thus a voltage according to the charges of the signal level of the floating diffusion FD2 is read out to the vertical signal line Vlin1. Then, a pixel signal S4L of the signal level is detected based on the voltage of the vertical signal line Vlin1 at this time. Then, a difference between the pixel signal S4L of the signal level and the pixel signal R4L of the black level is obtained, and thus a signal component according to the charges accumulated in the photoelectric conversion unit PD4L is detected.

Here, in the fourth read operation, it is possible to separate the capacities of the floating diffusions FD1 and FD2 through the switching transistor TRmix, and it is possible to reduce the capacity of the voltage converting unit that converts charges accumulated in the pixel PC into a voltage. Thus, it is possible to increase the conversion gain of the voltage converting unit and improve the SN ratio at the time of focusing.

Further, at the time of focusing, as the read order between the photoelectric conversion units PD1L and PD1R and the read order between the photoelectric conversion units PD2L and PD2R are reversed, it is possible to cause the centers of gravity of the accumulation periods of time of the photoelectric conversion units PD1L and PD2L to match the centers of gravity of the accumulation periods of time of the photoelectric conversion units PD1R and PD2R. Further, at the time of focusing, as the read order between the photoelectric conversion units PD3L and PD3R and the read order between the photoelectric conversion units PD4L and PD4R are reversed, it is possible to cause the centers of gravity of the accumulation periods of time of the photoelectric conversion units PD3L and PD4L to match the centers of gravity of the accumulation periods of time of the photoelectric conversion units PD3R and PD4R.

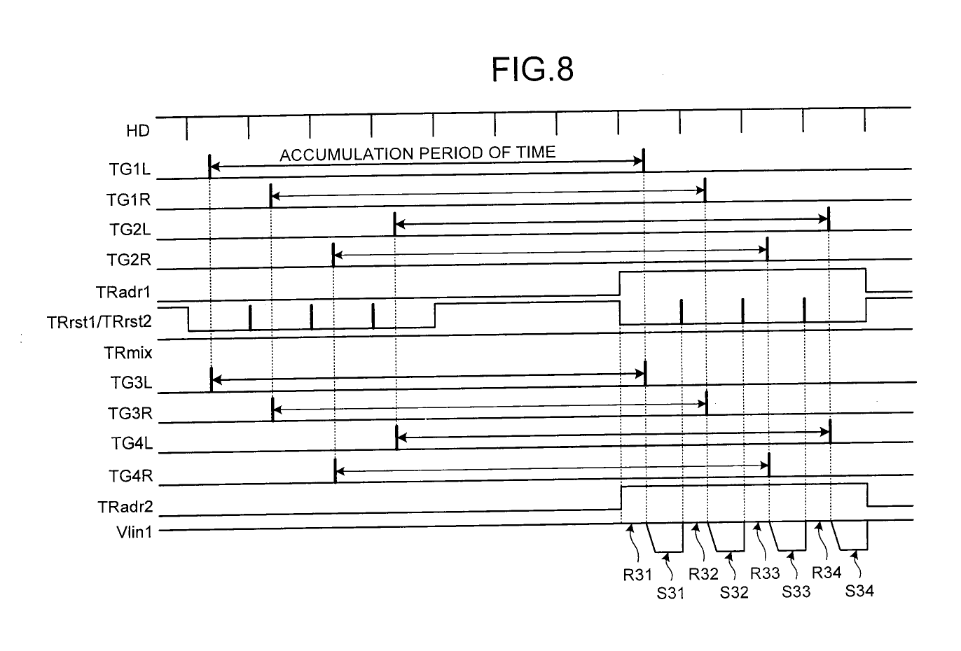

FIG. 8 is a timing chart illustrating voltage waveforms of the respective components when the pixel of FIG. 3 performs a fifth read operation.

Referring to FIG. 8, in the fifth read operation, as the switching transistor TRmix is turned on, the capacities of the floating diffusions FD1 and FD2 are combined.

Then, as the read transistors TG1L and TG3L are simultaneously turned on, the residual charges of the photoelectric conversion units PD1L and PD3L are discharged to the floating diffusions FD1 and FD2. Thereafter, as the read transistors TG1L and TG3L are simultaneously turned off, an operation of accumulating signal charges in the photoelectric conversion units PD1L and PD3L starts. Then, as the reset transistors TRrst1 and TRrst2 are turned on, the charges of the floating diffusions FD1 and FD2 are discharged, and then the reset transistors TRrst1 and TRrst2 are turned off.

After the reset transistors TRrst1 and TRrst2 are turned off, as the read transistors TG1R and TG3R are simultaneously turned on, the residual charges of the photoelectric conversion units PD1R and PD3R are discharged to the floating diffusions FD1 and FD2. Thereafter, as the read transistors TG1R and TG3R are simultaneously turned off, an operation of accumulating signal charges in the photoelectric conversion units PD1R and PD3R starts. Then, as the reset transistors TRrst1 and TRrst2 are turned on, the charges of the floating diffusions FD1 and FD2 are discharged, and then the reset transistors TRrst1 and TRrst2 are turned off.

After the reset transistors TRrst1 and TRrst2 are turned off, as the read transistors TG2R and TG4R are simultaneously turned on, the residual charges of the photoelectric conversion units PD2R and PD4R are discharged to the floating diffusions FD1 and FD2. Thereafter, as the read transistors TG2R and TG4R are simultaneously turned off, an operation of accumulating signal charges in the photoelectric conversion units PD2R and PD4R starts. Then, as the reset transistors TRrst1 and TRrst2 are turned on, the charges of the floating diffusions FD1 and FD2 are discharged, and then the reset transistors TRrst1 and TRrst2 are turned off.

After the reset transistors TRrst1 and TRrst2 are turned off, as the read transistors TG2L and TG4L are simultaneously turned on, the residual charges of the photoelectric conversion units PD2L and PD4L are discharged to the floating diffusions FD1 and FD2. Thereafter, as the read transistors TG2L and TG4L are simultaneously turned off, an operation of accumulating signal charges in the photoelectric conversion units PD2L and PD4L starts. Then, as the reset transistors TRrst1 and TRrst2 are turned on, the charges of the floating diffusions FD1 and FD2 are discharged, and then the reset transistors TRrst1 and TRrst2 are turned off.

Then, if the row selecting transistors TRadr1 and TRadr2 are turned on when the read transistors TG1L, TG1R, TG2L, TG2R, TG3L, TG3R, TG4L, and TG4R are in the off state, the amplifying transistors TRamp1 and TRamp2 perform the source follower operation, and thus a voltage according to the charges of the black level of the floating diffusions FD1 and FD2 is read out to the vertical signal line Vlin1. Then, a pixel signal R31 of the black level is detected based on the voltage of the vertical signal line Vlin1 at this time. Thereafter, as the read transistors TG1L and TG3L are turned on, the signal charges of the photoelectric conversion units PD1L and PD3L are read out to the floating diffusions FD1 and FD2. Then, the amplifying transistors TRamp1 and TRamp2 perform the source follower operation, and thus a voltage according to the charges of the signal level of the floating diffusions FD1 and FD2 is read out to the vertical signal line Vlin1. Then, a pixel signal S31 of the signal level is detected based on the voltage of the vertical signal line Vlin1 at this time. Then, a difference between the pixel signal S31 of the signal level and the pixel signal R31 of the black level is obtained, and thus a signal component according to the charges accumulated in the photoelectric conversion units PD1L and PD3L is detected.

After the pixel signal S31 of the signal level is output to the vertical signal line Vlin1, as the reset transistors TRrst1 and TRrst2 are turned on, the charges of the floating diffusions FD1 and FD2 are discharged. Then, if the row selecting transistors TRadr1 and TRadr2 are turned on when the read transistors TG1L, TG1R, TG2L, TG2R, TG3L, TG3R, TG4L, and TG4R are in the off state, the amplifying transistors TRamp1 and TRamp2 perform the source follower operation, and thus a voltage according to the charges of the black level of the floating diffusions FD1 and FD2 is read out to the vertical signal line Vlin1. Then, a pixel signal R32 of the black level is detected based on the voltage of the vertical signal line Vlin1 at this time. Thereafter, as the read transistors TG1R and TG3R are turned on, the signal charges of the photoelectric conversion units PD1R and PD3R are read out to the floating diffusions FD1 and FD2. Then, the amplifying transistors TRamp1 and TRamp2 perform the source follower operation, and thus a voltage according to the charges of the signal level of the floating diffusions FD1 and FD2 is read out to the vertical signal line Vlin1. Then, a pixel signal S32 of the signal level is detected based on the voltage of the vertical signal line Vlin1 at this time. Then, a difference between the pixel signal S32 of the signal level and the pixel signal R32 of the black level is obtained, and thus a signal component according to the charges accumulated in the photoelectric conversion units PD1R and PD3R is detected.

After the pixel signal S32 of the signal level is output to the vertical signal line Vlin1, as the reset transistors TRrst1 and TRrst2 are turned on, the charges of the floating diffusions FD1 and FD2 are discharged. Then, if the row selecting transistors TRadr1 and TRadr2 are turned on when the read transistors TG1L, TG1R, TG2L, TG2R, TG3L, TG3R, TG4L, and TG4R are in the off state, the amplifying transistors TRamp1 and TRamp2 perform the source follower operation, and thus a voltage according to the charges of the black level of the floating diffusions FD1 and FD2 is read out to the vertical signal line Vlin1. Then, a pixel signal R33 of the black level is detected based on the voltage of the vertical signal line Vlin1 at this time. Thereafter, as the read transistors TG2R and TG4R are turned on, the signal charges of the photoelectric conversion units PD2R and PD4R are read out to the floating diffusions FD1 and FD2. Then, the amplifying transistors TRamp1 and TRamp2 perform the source follower operation, and thus a voltage according to the charges of the signal level of the floating diffusions FD1 and FD2 is read out to the vertical signal line Vlin1. Then, a pixel signal S33 of the signal level is detected based on the voltage of the vertical signal line Vlin1 at this time. Then, a difference between the pixel signal S33 of the signal level and the pixel signal R33 of the black level is obtained, and thus a signal component according to the charges accumulated in the photoelectric conversion units PD2R and PD4R is detected.

After the pixel signal S33 of the signal level is output to the vertical signal line Vlin1, as the reset transistors TRrst1 and TRrst2 are turned on, the charges of the floating diffusions FD1 and FD2 are discharged. Then, if the row selecting transistors TRadr1 and TRadr2 are turned on when the read transistors TG1L, TG1R, TG2L, TG2R, TG3L, TG3R, TG4L, and TG4R are in the off state, the amplifying transistors TRamp1 and TRamp2 perform the source follower operation, and thus a voltage according to the charges of the black level of the floating diffusions FD1 and FD2 is read out to the vertical signal line Vlin1. Then, a pixel signal R34 of the black level is detected based on the voltage of the vertical signal line Vlin1 at this time. Thereafter, as the read transistors TG2L and TG4L are turned on, the signal charges of the photoelectric conversion units PD2L and PD4L are read out to the floating diffusions FD1 and FD2. Then, the amplifying transistors TRamp1 and TRamp2 perform the source follower operation, and thus a voltage according to the charges of the signal level of the floating diffusions FD1 and FD2 is read out to the vertical signal line Vlin1. Then, a pixel signal S34 of the signal level is detected based on the voltage of the vertical signal line Vlin1 at this time. Then, a difference between the pixel signal S34 of the signal level and the pixel signal R34 of the black level is obtained, and thus a signal component according to the charges accumulated in the photoelectric conversion units PD2L and PD4L is detected.

Here, in the fifth read operation, it is possible to combine the capacities of the floating diffusions FD1 and FD2 through the switching transistor TRmix and cause the pixels PC to perform the binning operation at the time of focusing. Accordingly, it is possible to read signals from the pixels PC in units of two lines and thus double the read speed. Further, it is possible to cause the source follower operations to be performed in parallel with the pixels PC of the two lines, and it is possible to reduce the noise of the pixel signal transferred via the vertical signal line Vlin1 to 1/√2.

Further, in the binning operation at the time of focusing, as the read order of the additional signal of the photoelectric conversion units PD1L and PD3L and the additional signal of the photoelectric conversion units PD1R and PD3R and the read order of the additional signal of the photoelectric conversion units PD2L and PD4L and the additional signal of the photoelectric conversion units PD2R and PD4R are reversed, it is possible to cause the centers of gravity of the accumulation periods of time of the photoelectric conversion units PD1L to PD4L to match the centers of gravity of the accumulation periods of time of the photoelectric conversion unit PD1R to PD4R.

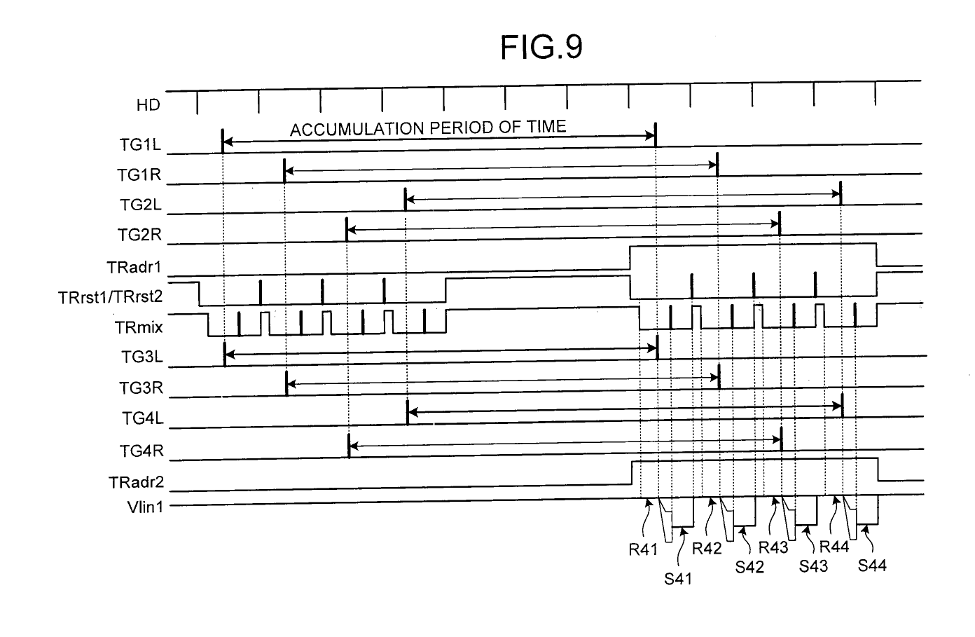

FIG. 9 is a timing chart illustrating voltage waveforms of the respective components when the pixel of FIG. 3 performs a sixth read operation.

Referring to FIG. 9, as the switching transistor TRmix is turned off, the capacities of the floating diffusions FD1 and FD2 are separated from each other. Then, as the read transistors TG1L and TG3L are simultaneously turned on, the residual charges of the photoelectric conversion units PD1L and PD3L are discharged to the floating diffusions FD1 and FD2. Thereafter, as the read transistors TG1L and TG3L are simultaneously turned off, an operation of accumulating signal charges in the photoelectric conversion units PD1L and PD3L starts. Then, as the reset transistors TRrst1 and TRrst2 are turned on, the charges of the floating diffusions FD1 and FD2 are discharged, and then the reset transistors TRrst1 and TRrst2 are turned off.

After the reset transistors TRrst1 and TRrst2 are turned off, as the read transistors TG1R and TG3R are simultaneously turned on, the residual charges of the photoelectric conversion units PD1R and PD3R are discharged to the floating diffusions FD1 and FD2. Thereafter, as the read transistors TG1R and TG3R are simultaneously turned off, an operation of accumulating signal charges in the photoelectric conversion units PD1R and PD3R starts. Then, as the reset transistors TRrst1 and TRrst2 are turned on, the charges of the floating diffusions FD1 and FD2 are discharged, and then the reset transistors TRrst1 and TRrst2 are turned off.

After the reset transistors TRrst1 and TRrst2 are turned off, as the read transistors TG2R and TG4R are simultaneously turned on, the residual charges of the photoelectric conversion units PD2R and PD4R are discharged to the floating diffusions FD1 and FD2. Thereafter, as the read transistors TG2R and TG4R are simultaneously turned off, an operation of accumulating signal charges in the photoelectric conversion units PD2R and PD4R starts. Then, as the reset transistors TRrst1 and TRrst2 are turned on, the charges of the floating diffusions FD1 and FD2 are discharged, and then the reset transistors TRrst1 and TRrst2 are turned off.

After the reset transistors TRrst1 and TRrst2 are turned off, as the read transistors TG2L and TG4L are simultaneously turned on, the residual charges of the photoelectric conversion units PD2L and PD4L are discharged to the floating diffusions FD1 and FD2. Thereafter, as the read transistors TG2L and TG4L are simultaneously turned off, an operation of accumulating signal charges in the photoelectric conversion units PD2L and PD4L starts. Then, as the reset transistors TRrst1 and TRrst2 are turned on, the charges of the floating diffusions FD1 and FD2 are discharged, and then the reset transistors TRrst1 and TRrst2 are turned off.

Then, if the row selecting transistors TRadr1 and TRadr2 are turned on when the read transistors TG1L, TG1R, TG2L, TG2R, TG3L, TG3R, TG4L, and TG4R are in the off state, the amplifying transistors TRamp1 and TRamp2 perform the source follower operation, and thus a voltage according to the charges of the black level of the floating diffusions FD1 and FD2 is read out to the vertical signal line Vlin1. Then, a pixel signal R41 of the black level is detected based on the voltage of the vertical signal line Vlin1 at this time. Thereafter, as the read transistors TG1L and TG3L are turned on, the signal charges of the photoelectric conversion units PD1L and PD3L are read out to the floating diffusions FD1 and FD2. Thereafter, as the switching transistor TRmix is turned on, the capacities of the floating diffusions FD1 and FD2 are combined, and the signal charges of the photoelectric conversion units PD1L and PD3L are averaged. Thereafter, as the switching transistor TRmix is turned off, the capacities of the floating diffusions FD1 and FD2 are separated from each other, and the averaged signal charges of the photoelectric conversion units PD1L and PD3L are divided. Then, the amplifying transistors TRamp1 and TRamp2 perform the source follower operation, and thus a voltage according to the charges of the signal level of the floating diffusions FD1 and FD2 is read out to the vertical signal line Vlin1. Then, the pixel signal S41 of the signal level is detected based on the voltage of the vertical signal line Vlin1 at this time. Then, a difference between the pixel signal S41 of the signal level and the pixel signal R41 of the black level is obtained, and thus a signal component according to the charges accumulated in the photoelectric conversion units PD1L and PD3L is detected.

After the pixel signal S41 of the signal level is output to the vertical signal line Vlin1, as the reset transistors TRrst1 and TRrst2 are turned on, the charges of the floating diffusions FD1 and FD2 are discharged. Then, if the row selecting transistors TRadr1 and TRadr2 are turned on when the read transistors TG1L, TG1R, TG2L, TG2R, TG3L, TG3R, TG4L, and TG4R are in the off state, the amplifying transistors TRamp1 and TRamp2 perform the source follower operation, and thus a voltage according to the charges of the black level of the floating diffusions FD1 and FD2 is read out to the vertical signal line Vlin1. Then, a pixel signal R42 of the black level is detected based on the voltage of the vertical signal line Vlin1 at this time. Thereafter, as the read transistors TG1R and TG3R are turned on, the signal charges of the photoelectric conversion units PD1R and PD3R are read out to the floating diffusions FD1 and FD2. Thereafter, as the switching transistor TRmix is turned on, the capacities of the floating diffusions FD1 and FD2 are combined, and the signal charges of the photoelectric conversion units PD1R and PD3R are averaged. Thereafter, as the switching transistor TRmix is turned off, the capacities of the floating diffusions FD1 and FD2 are separated from each other, the averaged signal charges of the photoelectric conversion units PD1R and PD3R are divided. Then, the amplifying transistors TRamp1 and TRamp2 perform the source follower operation, and thus a voltage according to the charges of the signal level of the floating diffusions FD1 and FD2 is read out to the vertical signal line Vlin1. Then, a pixel signal S42 of the signal level is detected based on the voltage of the vertical signal line Vlin1 at this time. Then, a difference between the pixel signal S42 of the signal level and the pixel signal R42 of the black level is obtained, and thus a signal component according to the charges accumulated in the photoelectric conversion units PD1R and PD3R is detected.

After the pixel signal S42 of the signal level is output to the vertical signal line Vlin1, as the reset transistors TRrst1 and TRrst2 are turned on, the charges of the floating diffusions FD1 and FD2 are discharged. Then, if the row selecting transistors TRadr1 and TRadr2 are turned on when the read transistors TG1L, TG1R, TG2L, TG2R, TG3L, TG3R, TG4L, and TG4R are in the off state, the amplifying transistors TRamp1 and TRamp2 perform the source follower operation, and thus a voltage according to the charges of the black level of the floating diffusions FD1 and FD2 is read out to the vertical signal line Vlin1. Then, a pixel signal R43 of the black level is detected based on the voltage of the vertical signal line Vlin1 at this time. Thereafter, as the read transistors TG2R and TG4R are turned on, the signal charges of the photoelectric conversion units PD2R and PD4R are read out to the floating diffusions FD1 and FD2. Thereafter, as the switching transistor TRmix is turned on, the capacities of the floating diffusions FD1 and FD2 are combined, and the signal charges of the photoelectric conversion units PD2R and PD4R are averaged. Thereafter, as the switching transistor TRmix is turned off, the capacities of the floating diffusions FD1 and FD2 are separated from each other, and the averaged signal charges of the photoelectric conversion units PD2R and PD4R are divided. Then, the amplifying transistors TRamp1 and TRamp2 perform the source follower operation, and thus a voltage according to the charges of the signal level of the floating diffusions FD1 and FD2 is read out to the vertical signal line Vlin1. Then, a pixel signal S43 of the signal level is detected based on the voltage of the vertical signal line Vlin1 at this time. Then, a difference between the pixel signal S43 of the signal level and the pixel signal R43 of the black level is obtained, and thus a signal component according to the charges accumulated in the photoelectric conversion units PD2R and PD4R is detected.

After the pixel signal S43 of the signal level is output to the vertical signal line Vlin1, as the reset transistors TRrst1 and TRrst2 are turned on, the charges of the floating diffusions FD1 and FD2 are discharged. Then, if the row selecting transistors TRadr1 and TRadr2 are turned on when the read transistors TG1L, TG1R, TG2L, TG2R, TG3L, TG3R, TG4L, and TG4R are in the off state, the amplifying transistors TRamp1 and TRamp2 perform the source follower operation, and thus a voltage according to the charges of the black level of the floating diffusions FD1 and FD2 is read out to the vertical signal line Vlin1. Then, a pixel signal R44 of the black level is detected based on the voltage of the vertical signal line Vlin1 at this time. Thereafter, as the read transistors TG2L and TG4L are turned on, the signal charges of the photoelectric conversion units PD2L and PD4L are read out to the floating diffusions FD1 and FD2. Thereafter, as the switching transistor TRmix is turned on, the capacities of the floating diffusions FD1 and FD2 are combined, and the signal charges of the photoelectric conversion units PD2L and PD4L are averaged. Thereafter, as the switching transistor TRmix is turned off, the capacities of the floating diffusions FD1 and FD2 are separated from each other, and the averaged signal charges of the photoelectric conversion units PD2L and PD4L are divided. Then, the amplifying transistors TRamp1 and TRamp2 perform the source follower operation, and thus a voltage according to the charges of the signal level of the floating diffusions FD1 and FD2 is read out to the vertical signal line Vlin1. Then, a pixel signal S44 of the signal level is detected based on the voltage of the vertical signal line Vlin1 at this time. Then, a difference between the pixel signal S44 of the signal level and the pixel signal R44 of the black level is obtained, and thus a signal component according to the charges accumulated in the photoelectric conversion units PD2L and PD4L is detected.

Here, in the sixth read operation, it is possible to cause the amplifying transistors TRampA1 and TRamp2 of the two lines to perform the source follower operations in parallel at the time of imaging, and it is possible to reduce the noise of the pixel signals R41 to R44 of the black level and the pixel signals S41 to S44 of the signal level transferred via the vertical signal lines Vlin1 to 1/√2. Further, as the switching transistor TRmix is turned on after signal reading, it is possible to cause the potential of the floating diffusion FD1 to be equivalent to the potential of the floating diffusion FD2, and it is possible to reduce the potential difference between the floating diffusions FD1 and FD2 to about several 10 mV. Even when there is a potential difference of 0.3 V to 0.5 V between the floating diffusions FD1 and FD2 after signal reading at the time of imaging, the signal averaged by the source follower operation can be output to the vertical signal line Vlin1.

Further, in the binning operation at the time of focusing, the read order of the additional signal of the photoelectric conversion units PD1L and PD3L and the additional signal of the photoelectric conversion units PD1R and PD3R and the read order of the additional signal of the photoelectric conversion units PD2L and PD4L and the additional signal of the photoelectric conversion units PD2R and PD4R are reversed, and thus it is possible to cause the centers of gravity of the accumulation periods of time of the photoelectric conversion unit PD1L to PD4L to match the centers of gravity of the accumulation periods of time of the photoelectric conversion unit PD1R to PD4R.

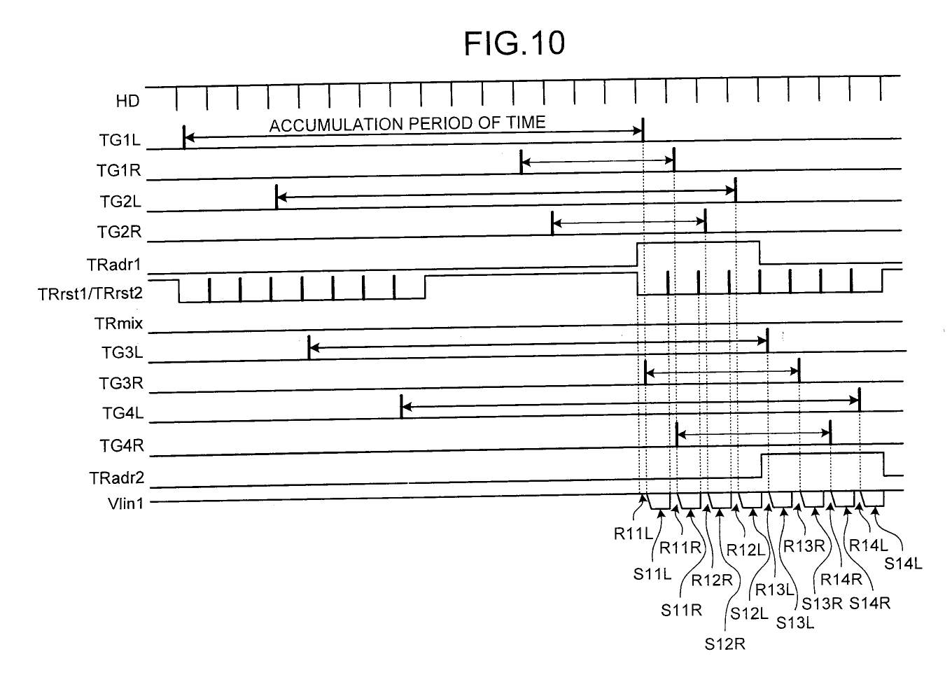

FIG. 10 is a timing chart illustrating voltage waveforms of the respective components when the pixel of FIG. 3 performs a seventh read operation.

Referring to FIG. 10, in the seventh read operation, as the switching transistor TRmix is turned off, the capacities of the floating diffusions FD1 and FD2 are separated from each other.

Then, as the read transistor TG1L is turned on, the residual charges of the photoelectric conversion unit PD1L are discharged to the floating diffusion FD1. Thereafter, as the read transistor TG1L is turned off, an operation of accumulating signal charges in the photoelectric conversion unit PD1L starts. Then, as the reset transistors TRrst1 and TRrst2 are turned on, the charges of the floating diffusion FD1 are discharged.

Further, after the operation of accumulating signal charges in the photoelectric conversion unit PD1L starts, as the read transistor TG1R is turned on, the residual charges of the photoelectric conversion unit PD1R are discharged to the floating diffusion FD1. Thereafter, as the read transistor TG1R is turned off, an operation of accumulating signal charges in the photoelectric conversion unit PD1R starts. Then, as the reset transistors TRrst1 and TRrst2 are turned on, the charges of the floating diffusion FD1 are discharged.

Further, as the read transistor TG2L is turned on, the residual charges of the photoelectric conversion unit PD2L are discharged to the floating diffusion FD1. Thereafter, as the read transistor TG2L is turned off, an operation of accumulating signal charges in the photoelectric conversion unit PD2L starts. Then, as the reset transistors TRrst1 and TRrst2 are turned on, the charges of the floating diffusion FD1 are discharged.

After the operation of accumulating signal charges in the photoelectric conversion unit PD2L starts, as the read transistor TG2R is turned on, the residual charges of the photoelectric conversion unit PD2R are discharged to the floating diffusion FD1. Thereafter, as the read transistor TG2R is turned off, an operation of accumulating signal charges in the photoelectric conversion unit PD2R starts. Then, as the reset transistors TRrst1 and TRrst2 are turned on, the charges of the floating diffusion FD1 are discharged.

Further, as the read transistor TG3L is turned on, the residual charges of the photoelectric conversion unit PD3L are discharged to the floating diffusion FD2. Thereafter, as the read transistor TG3L is turned off, an operation of accumulating signal charges in the photoelectric conversion unit PD3L starts. Then, as the reset transistors TRrst1 and TRrst2 are turned on, the charges of the floating diffusion FD2 are discharged.

After the operation of accumulating signal charges in the photoelectric conversion unit PD3L starts, as the read transistor TG3R is turned on, the residual charges of the photoelectric conversion unit PD3R are discharged to the floating diffusion FD2. Thereafter, as the read transistor TG3R is turned off, an operation of accumulating signal charges in the photoelectric conversion unit PD3R starts. Then, as the reset transistors TRrst1 and TRrst2 are turned on, the charges of the floating diffusion FD2 are discharged.

Further, as the read transistor TG4L is turned on, the residual charges of the photoelectric conversion unit PD4L are discharged to the floating diffusion FD2. Thereafter, as the read transistor TG4L is turned off, an operation of accumulating signal charges in the photoelectric conversion unit PD4L starts. Then, as the reset transistors TRrst1 and TRrst2 are turned on, the charges of the floating diffusion FD2 are discharged.

After the operation of accumulating signal charges in the photoelectric conversion unit PD4L starts, as the read transistor TG4R is turned on, the residual charges of the photoelectric conversion unit PD4R are discharged to the floating diffusion FD2. Thereafter, as the read transistor TG4R is turned off, an operation of accumulating signal charges in the photoelectric conversion unit PD4R starts. Then, as the reset transistors TRrst1 and TRrst2 are turned on, the charges of the floating diffusion FD2 are discharged.

Here, the accumulation periods of time of the photoelectric conversion units PD1L, PD2L, PD3L, and PD4L may be set to be different from the accumulation periods of time of the photoelectric conversion units PD1R, PD2R, PD3R, and PD4R.

Then, if the row selecting transistor TRadr1 is turned on when the read transistors TG1L, TG1R, TG2L, and TG2R are in the off state, the amplifying transistor TRamp1 performs the source follower operation, and thus a voltage according to the charges of the black level of the floating diffusion FD1 is read out to the vertical signal line Vlin1. Then, a pixel signal R11L of the black level is detected based on the voltage of the vertical signal line Vlin1 at this time. Thereafter, as the read transistor TG1L is turned on, the signal charges of the photoelectric conversion unit PD1L are read out to the floating diffusion FD1. Then, the amplifying transistor TRamp1 performs the source follower operation, and thus a voltage according to the charges of the signal level of the floating diffusion FD1 is read out to the vertical signal line Vlin1. Then, the pixel signal S11L of the signal level is detected based on the voltage of the vertical signal line Vlin1 at this time. Then, a difference between the pixel signal S11L of the signal level and the pixel signal R11L of the black level is obtained, and thus a signal component according to the charges accumulated in the photoelectric conversion unit PD1L is detected.

After the pixel signal S11L of the signal level is output to the vertical signal line Vlin1, as the reset transistor TRrst1 is turned on, the charges of the floating diffusion FD1 are discharged. Then, if the row selecting transistor TRadr1 is turned on when the read transistors TG1L, TG1R, TG2L, and TG2R are in the off state, the amplifying transistor TRamp1 performs the source follower operation, and thus a voltage according to the charges of the black level of the floating diffusion FD1 is read out to the vertical signal line Vlin1. Then, a pixel signal R11R of the black level is detected based on the voltage of the vertical signal line Vlin1 at this time. Thereafter, as the read transistor TG1R is turned on, the signal charges of the photoelectric conversion unit PD1R are read out to the floating diffusion FD1. Then, the amplifying transistor TRamp1 performs the source follower operation, and thus a voltage according to the charges of the signal level of the floating diffusion FD1 is read out to the vertical signal line Vlin1. Then, a pixel signal S11R of the signal level is detected based on the voltage of the vertical signal line Vlin1 at this time. Then, a difference between the pixel signal S11R of the signal level and the pixel signal R11R of the black level is obtained, and thus a signal component according to the charges accumulated in the photoelectric conversion unit PD1R is detected.

After the pixel signal S11R of the signal level is output to the vertical signal line Vlin1, as the reset transistor TRrst1 is turned on, the charges of the floating diffusion FD1 are discharged. Then, if the row selecting transistor TRadr1 is turned on when the read transistors TG1L, TG1R, TG2L, and TG2R are in the off state, the amplifying transistor TRamp1 performs the source follower operation, and thus a voltage according to the charges of the black level of the floating diffusion FD1 is read out to the vertical signal line Vlin1. Then, a pixel signal R12L of the black level is detected based on the voltage of the vertical signal line Vlin1 at this time. Thereafter, as the read transistor TG2L is turned on, the signal charges of the photoelectric conversion unit PD2L are read out to the floating diffusion FD1. Then, the amplifying transistor TRamp1 performs the source follower operation, and thus a voltage according to the charges of the signal level of the floating diffusion FD1 is read out to the vertical signal line Vlin1. Then, a pixel signal S12L of the signal level is detected based on the voltage of the vertical signal line Vlin1 at this time. Then, a difference between the pixel signal S12L of the signal level and the pixel signal R12L of the black level is obtained, and thus a signal component according to the charges accumulated in the photoelectric conversion unit PD2L is detected.

After the pixel signal S12L of the signal level is output to the vertical signal line Vlin1, as the reset transistor TRrst1 is turned on, the charges of the floating diffusion FD1 are discharged. Then, if the row selecting transistor TRadr1 is turned on when the read transistors TG1L, TG1R, TG2L, and TG2R are in the off state, the amplifying transistor TRamp1 performs the source follower operation, and thus a voltage according to the charges of the black level of the floating diffusion FD1 is read out to the vertical signal line Vlin1. Then, a pixel signal R12R of the black level is detected based on the voltage of the vertical signal line Vlin1 at this time. Thereafter, as the read transistor TG2R is turned on, the signal charges of the photoelectric conversion unit PD2R are read out to the floating diffusion FD1. Then, the amplifying transistor TRamp1 performs the source follower operation, and thus a voltage according to the charges of the signal level of the floating diffusion FD1 is read out to the vertical signal line Vlin1. Then, a pixel signal S12R of the signal level is detected based on the voltage of the vertical signal line Vlin1 at this time. Then, a difference between the pixel signal S12R of the signal level and the pixel signal R12R of the black level is obtained, and thus a signal component according to the charges accumulated in the photoelectric conversion unit PD2R is detected.

Then, if the row selecting transistor TRadr2 is turned on when the read transistors TG3L, TG3R, TG4L, and TG4R are in the off state, the amplifying transistor TRamp2 performs the source follower operation, and thus a voltage according to the charges of the black level of the floating diffusion FD2 is read out to the vertical signal line Vlin1. Then, a pixel signal R13L of the black level is detected based on the voltage of the vertical signal line Vlin1 at this time. Thereafter, as the read transistor TG3L is turned on, the signal charges of the photoelectric conversion unit PD3L are read out to the floating diffusion FD2. Then, as the amplifying transistor TRamp2 performs the source follower operation, and thus a voltage according to the charges of the signal level of the floating diffusion FD2 is read out to the vertical signal line Vlin1. Then, a pixel signal S13L of the signal level is detected based on the voltage of the vertical signal line Vlin1 at this time. Then, a difference between the pixel signal S13L of the signal level and the pixel signal R13L of the black level is obtained, and thus a signal component according to the charges accumulated in the photoelectric conversion unit PD3L is detected.

After the pixel signal S13L of the signal level is output to the vertical signal line Vlin1, as the reset transistor TRrst2 is turned on, the charges of the floating diffusion FD2 are discharged. Then, if the row selecting transistor TRadr2 is turned on when the read transistors TG3L, TG3R, TG4L, and TG4R are in the off state, the amplifying transistor TRamp2 performs the source follower operation, and thus a voltage according to the charges of the black level of the floating diffusion FD2 is read out to the vertical signal line Vlin1. Then, a pixel signal R13R of the black level is detected based on the voltage of the vertical signal line Vlin1 at this time. Thereafter, as the read transistor TG3R is turned on, the signal charges of the photoelectric conversion unit PD3R are read out to the floating diffusion FD2. Then, as the amplifying transistor TRamp2 performs the source follower operation, and thus a voltage according to the charges of the signal level of the floating diffusion FD2 is read out to the vertical signal line Vlin1. Then, a pixel signal S13R of the signal level is detected based on the voltage of the vertical signal line Vlin1 at this time. Then, a difference between the pixel signal S13R of the signal level and the pixel signal R13R of the black level is obtained, and thus a signal component according to the charges accumulated in the photoelectric conversion unit PD3R is detected.

After the pixel signal S13R of the signal level is output to the vertical signal line Vlin1, as the reset transistor TRrst2 is turned on, the charges of the floating diffusion FD2 are discharged. Then, if the row selecting transistor TRadr2 is turned on when the read transistors TG3L, TG3R, TG4L, and TG4R are in the off state, the amplifying transistor TRamp2 performs the source follower operation, and thus a voltage according to the charges of the black level of the floating diffusion FD2 is read out to the vertical signal line Vlin1. Then, a pixel signal R14L of the black level is detected based on the voltage of the vertical signal line Vlin1 at this time. Thereafter, as the read transistor TG4L is turned on, the signal charges of the photoelectric conversion unit PD4L are read out to the floating diffusion FD2. Then, as the amplifying transistor TRamp2 performs the source follower operation, and thus a voltage according to the charges of the signal level of the floating diffusion FD2 is read out to the vertical signal line Vlin1. Then, a pixel signal S14L of the signal level is detected based on the voltage of the vertical signal line Vlin1 at this time. Then, a difference between the pixel signal S14L of the signal level and the pixel signal R14L of the black level is obtained, and thus a signal component according to the charges accumulated in the photoelectric conversion unit PD4L is detected.

After the pixel signal S14L of the signal level is output to the vertical signal line Vlin1, as the reset transistor TRrst2 is turned on, the charges of the floating diffusion FD2 are discharged. Then, if the row selecting transistor TRadr2 is turned on when the read transistors TG3L, TG3R, TG4L, and TG4R are in the off state, the amplifying transistor TRamp2 performs the source follower operation, and thus a voltage according to the charges of the black level of the floating diffusion FD2 is read out to the vertical signal line Vlin1. Then, a pixel signal R14R of the black level is detected based on the voltage of the vertical signal line Vlin1 at this time. Thereafter, as the read transistor TG4R is turned on, the signal charges of the photoelectric conversion unit PD4R are read out to the floating diffusion FD2. Then, as the amplifying transistor TRamp2 performs the source follower operation, and thus a voltage according to the charges of the signal level of the floating diffusion FD2 is read out to the vertical signal line Vlin1. Then, a pixel signal S14R of the signal level is detected based on the voltage of the vertical signal line Vlin1 at this time. Then, a difference between the pixel signal S14R of the signal level and the pixel signal R14R of the black level is obtained, and thus a signal component according to the charges accumulated in the photoelectric conversion unit PD4R is detected.

Here, in the seventh read operation, it is possible to separate the capacities of the floating diffusions FD1 and FD2 through the switching transistor TRmix, and it is possible to reduce the capacity of the voltage converting unit that converts charges accumulated in the pixel PC into a voltage. Thus, it is possible to increase the conversion gain of the voltage converting unit and improve the SN ratio at the time of focusing. Further, as the accumulation periods of time of the photoelectric conversion units PD1L, PD2L, PD3L, and PD4L are set to be different from the accumulation periods of time of the photoelectric conversion units PD1R, PD2R, PD3R, and PD4R, even when signals of the photoelectric conversion units having a longer accumulation period of time are saturated, it is possible to prevent signals of the photoelectric conversion units having a shorter accumulation period of time from being saturated. Thus, as the signals are linearized by a subsequent combination process, the dynamic range can be increased.

The switching transistor TRmix may function as a conversion capacity switching unit that changes the conversion capacity of the voltage converting unit. For example, at a time of low luminance shooting, the conversion capacity is reduced, a high conversion gain is set, and thus a high S/N image quality in which influence of circuit noise at a subsequent stage is reduced can be obtained. Further, at a time of high luminance shooting, the conversion capacity is increased, a low conversion gain is set, the saturation electron number of the voltage converting unit is increased, and thus a high S/N image quality in which influence of light shot noise is reduced can be obtained.

### Third Embodiment

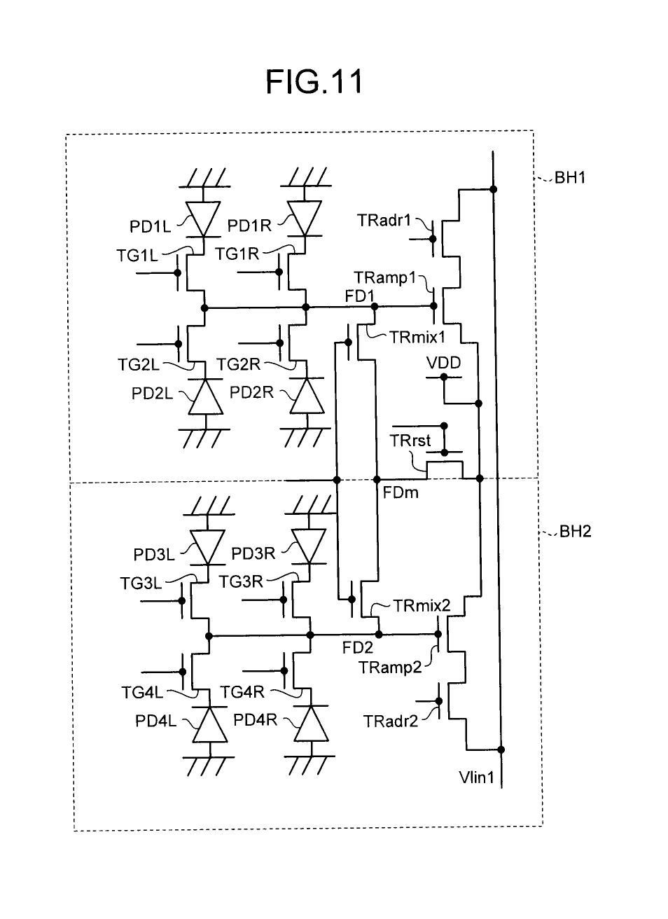

FIG. 11 is a circuit diagram illustrating an exemplary pixel configuration of 1×4 pixels in a 2-pixel 1-cell configuration of a solid-state imaging device according to a third embodiment.

Referring to FIG. 11, in the solid-state imaging device, switching transistors TRmix1 and TRmix2 are disposed instead of the switching transistor TRmix of FIG. 3. A reset transistor TRrst is disposed instead of the reset transistors TRrst1 and TRrst1 of FIG. 3.

The switching transistors TRmix1 and TRmix2 are connected to each other in series, and the serial circuit is connected between the floating diffusions FD1 and FD2. The gates of the switching transistors TRmix1 and TRmix2 are mutually connected. The reset transistor TRrst is connected between the connection point of the switching transistors TRmix1 and TRmix2 and the power potential VDD. A floating diffusion FDm is formed at the connection point of the switching transistors TRmix1 and TRmix2. The switching transistor TRmix1 may be arranged to be adjacent to the floating diffusion FD1. The switching transistor TRmix2 may be arranged to be adjacent to the floating diffusion FD2.

The switching transistors TRmix1 and TRmix2 may operate, similarly to the switching transistor TRmix, and the reset transistor TRrst may operate, similarly to the reset transistors TRrst1 and TRrst2.

Here, as the switching transistors TRmix1 and TRmix2 are arranged to be adjacent to the floating diffusions FD1 and FD2, it is possible to reduce an interconnection capacity added to the floating diffusions FD1 and FD2, and it is possible to increase the conversion gain. In addition, the two reset transistors TRrst1 and TRrst2 of FIG. 3 can be replaced with one transistor.

The switching transistors TRmix1 and TRmix2 may function as a conversion capacity switching unit that changes the conversion capacity of the voltage converting unit.

### Fourth Embodiment

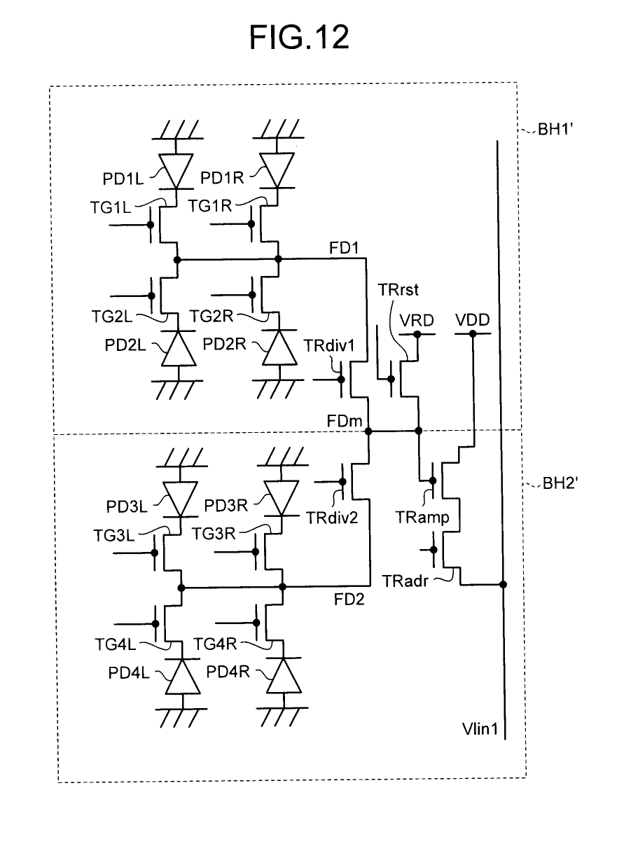

FIG. 12 is a circuit diagram illustrating an exemplary pixel configuration of 1×4 pixels in a 2-pixel 1-cell configuration of a solid-state imaging device according to a fourth embodiment.

Referring to FIG. 12, the pixel array unit 1 is division transistors TRdiv1 and TRdiv2 that divide a voltage converting unit that converts the charges generated by the pixels PC into a voltage into a first voltage converting unit and a second voltage converting unit. In other words, the division transistors TRdiv1 and TRdiv2 can function as a conversion capacity switching unit that changes the conversion capacity of the voltage converting unit.

The division transistor TRdiv1 or the division transistor TRdiv2 may be disposed for each pixel PC. Here, at the time of low luminance shooting, it is possible to increase the conversion gain by dividing the voltage converting unit through the division transistors TRdiv1 and TRdiv2. Further, at the time of high luminance shooting, it is possible to increase the saturation electron number by causing the voltage converting unit to be not divided through the division transistors TRdiv1 and TRdiv2. The division transistors TRdiv1 and TRdiv2 may be automatically switched based on an external luminance measurement result or may be arbitrarily switched by the user.

Here, when the capacity of the voltage converting unit is divided, it is possible to reduce the capacity of the voltage converting unit that converts charges accumulated in the pixel PC into a voltage to be smaller than when the capacity of the voltage converting unit is not divided, and thus it is possible to improve an SN ratio. Meanwhile, when the capacity of the voltage converting unit is not divided, it is possible to increase the saturation electron number of the voltage converting unit to be larger than when the capacity of the voltage converting unit is divided, and thus it is possible to increase the dynamic range.

A connection relation between the division transistors TRdiv1 and TRdiv2 will be specifically described below. Here, Bayer arrays BH1′ and BH2′ are assumed to be arranged to be adjacent in the column direction CD.

In the Bayer array BH1′, a first photoelectric conversion unit PD1L and a second photoelectric conversion unit PD1R are disposed for the green pixel Gr, and a first photoelectric conversion unit PD2L and a second photoelectric conversion unit PD2R are disposed for the blue pixel B. In the Bayer array BH2′, a first photoelectric conversion unit PD3L and a second photoelectric conversion unit PD3R are disposed for the green pixel Gr, and a first photoelectric conversion unit PD4L and a second photoelectric conversion unit PD4R are disposed for the blue pixel B. Further, the Bayer array BH1′ is provided with read transistors TG1L, TG1R, TG2L, and TG2R and a division transistor TRdiv1, and the Bayer array BH2′ is provided with read transistors TG3L, TG3R, TG4L, and TG4R and a division transistor TRdiv2. The row selecting transistor TRadr, the amplifying transistor TRamp, and the reset transistor TRrst are disposed to be common to the Bayer arrays BH1′ and BH2′. A floating diffusion FD1 is formed at a connection point of the read transistors TG1L, TG1R, TG2L, and TG2R as a first voltage converting unit, and a floating diffusion FDm is formed at a connection point of the amplifying transistor TRamp and the reset transistor TRrst as a second voltage converting unit, and a floating diffusion FD2 is formed at a connection point of the read transistors TG3L, TG3R, TG4L, and TG4R as a third voltage converting unit.

Then, the first photoelectric conversion unit PD1L is connected to the floating diffusion FD1 via the read transistor TG1L, the second photoelectric conversion unit PD1R is connected to the floating diffusion FD1 via the read transistor TG1R, the first photoelectric conversion unit PD2L is connected to the floating diffusion FD1 via the read transistor TG2L, and the second photoelectric conversion unit PD2R is connected to the floating diffusion FD1 via the read transistor TG2R. The first photoelectric conversion unit PD3L is connected to the floating diffusion FD2 via the read transistor TG3L, the second photoelectric conversion unit PD3R is connected to the floating diffusion FD2 via the read transistor TG3R, the first photoelectric conversion unit PD4L is connected to the floating diffusion FD2 via the read transistor TG4L, and the second photoelectric conversion unit PD4R is connected to the floating diffusion FD2 via the read transistor TG4R.

A gate of the amplifying transistor TRamp is connected to the floating diffusion FDm, a source of the amplifying transistor TRamp is connected to the vertical signal line Vlin1 via the row selecting transistor TRadr, and a drain of the amplifying transistor TRamp is connected to the power potential VDD. The floating diffusion FDm is connected to the power potential VRD via the reset transistor TRrst.

The division transistor TRdiv1 is connected between the floating diffusions FD1 and FDm, and the division transistor TRdiv2 is connected between the floating diffusions FD2 and FDm.

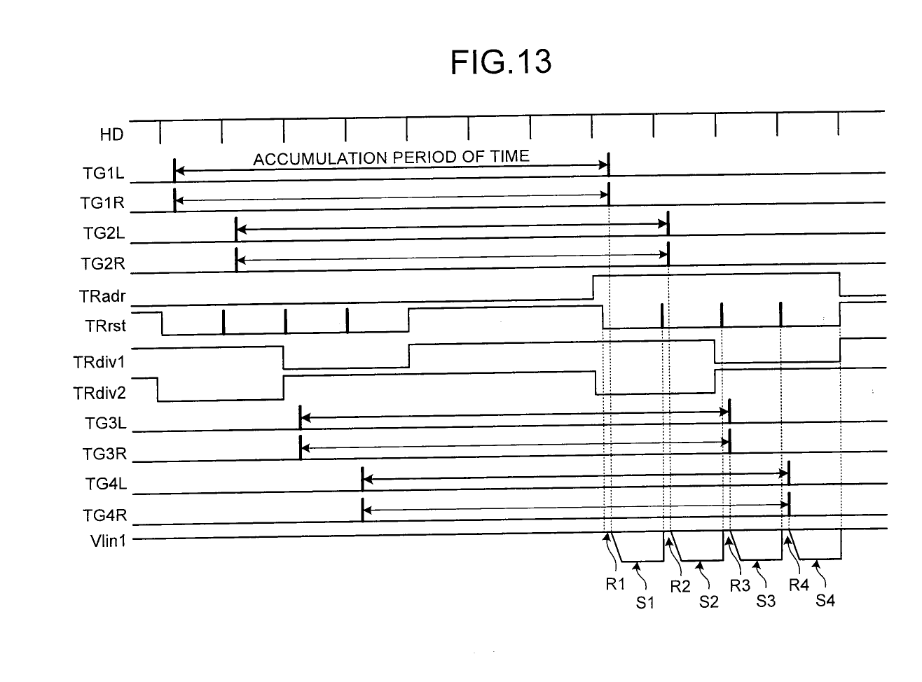

FIG. 13 is a timing chart illustrating voltage waveforms of the respective components when the pixel of FIG. 12 performs a first read operation.

In the first read operation of FIG. 4, as the switching transistor TRmix is turned off, the capacities of the floating diffusions FD1 and FD2 are separated from each other. On the other hand, in the first read operation of FIG. 13, when signals of the first photoelectric conversion units PD1L and PD2L and the second photoelectric conversion units PD1R and PD2R are detected, the division transistor TRdiv1 is turned on, and the division transistor TRdiv2 is turned off, so that the capacity of the floating diffusion FD2 is separated from the capacities of the floating diffusions FD1 and FDm. When signals of the first photoelectric conversion units PD3L and PD4L and the second photoelectric conversion units PD3R and PD4R are detected, the division transistor TRdiv1 is turned off, and the division transistor TRdiv2 is turned on, so that the capacity of the floating diffusion FD1 is separated from the capacities of the floating diffusions FD2 and FDm.

The remaining operations are similar to the first read operation of FIG. 4, and thus the pixel signals S1 to S4 of the signal level and the pixel signals R1 to R4 of the black level can be obtained.

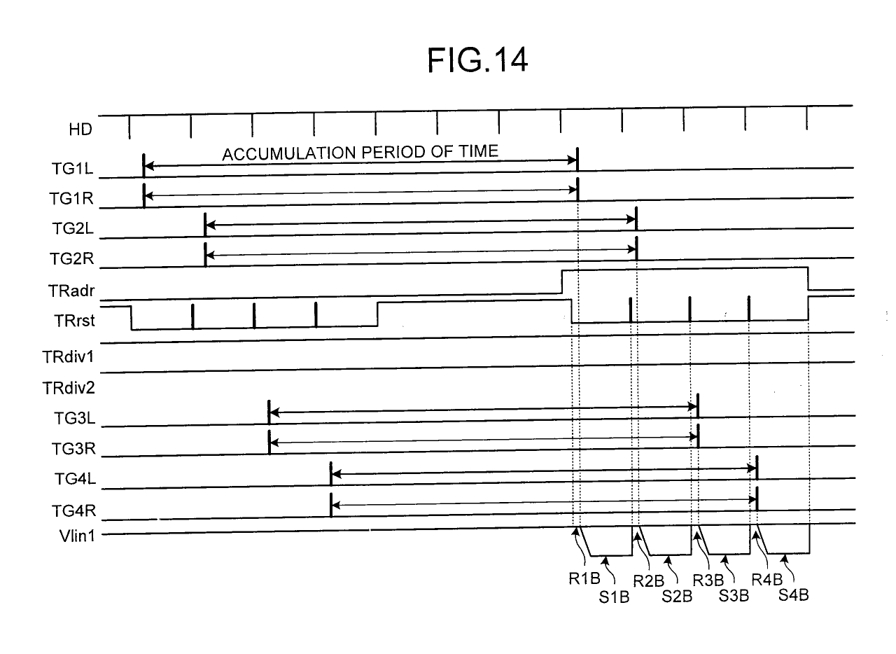

FIG. 14 is a timing chart illustrating voltage waveforms of the respective components when the pixel of FIG. 12 performs a second read operation.

In the first read operation of FIG. 13, when signals of the first photoelectric conversion units PD1L and PD2L and the second photoelectric conversion units PD1R and PD2R are detected, the capacity of the floating diffusion FD2 is separated from the capacities of the floating diffusions FD1 and FDm, and when signals of the first photoelectric conversion units PD3L and PD4L and the second photoelectric conversion units PD3R and PD4R are detected, the capacity of the floating diffusion FD1 is separated from the capacities of the floating diffusions FD2 and FDm. On the other hand, in the second read operation of FIG. 14, as the division transistors TRdiv1 and TRdiv2 is turned on, the capacities of the floating diffusions FD1, FD2, and FDm are combined. The remaining operations are similar to the first read operation of FIG. 13, and it is possible to reduce the conversion gain to be lower than that of the method of FIG. 13 and obtain the pixel signals SIB to S4B of the signal level and the pixel signals R1B to R4B of the black level.

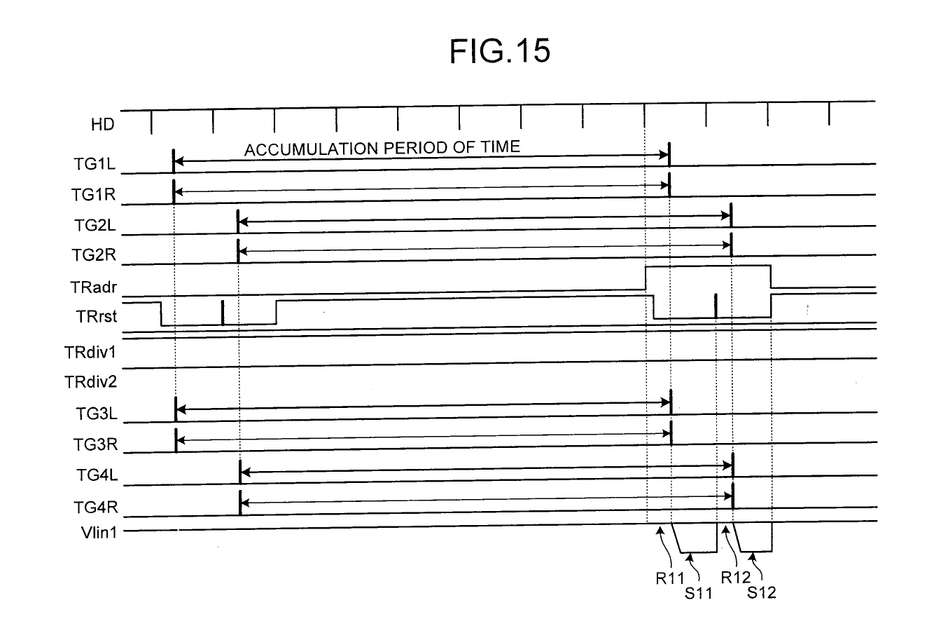

FIG. 15 is a timing chart illustrating voltage waveforms of the respective components when the pixel of FIG. 12 performs a third read operation.

In the second read operation of FIG. 5, as the switching transistor TRmix is turned on, the capacities of the floating diffusions FD1 and FD2 are combined. On the other hand, in the third read operation of FIG. 15, as the division transistors TRdiv1 and TRdiv2 are turned on, the capacities of the floating diffusions FD1, FD2, and FDm are combined.

The remaining operations are similar to the third read operation of FIG. 5, and thus it is possible to obtain the pixel signals S11 to S14 of the signal level and the pixel signals R11 to R14 of the black level.

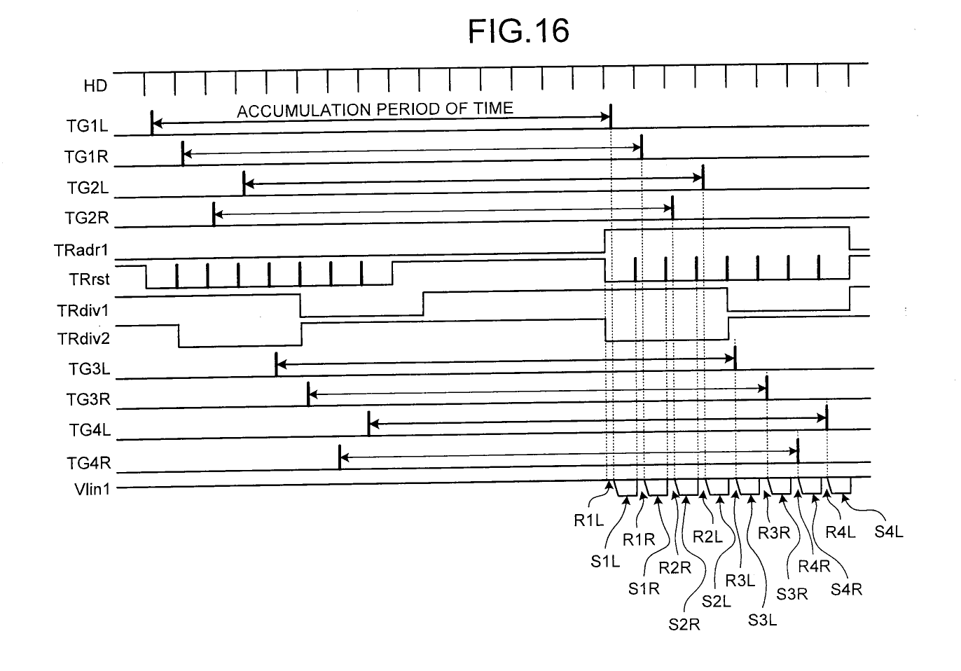

FIG. 16 is a timing chart illustrating voltage waveforms of the respective components when the pixel of FIG. 12 performs a fourth read operation.

In the fourth read operation of FIG. 7, as the switching transistor TRmix is turned off, the capacities of the floating diffusions FD1 and FD2 are separated from each other. On the other hand, in the fourth read operation of FIG. 16, when signals of the first photoelectric conversion units PD1L and PD2L and the second photoelectric conversion units PD1R and PD2R are detected, the division transistor TRdiv1 is turned on, and the division transistor TRdiv2 is turned off, so that the capacity of the floating diffusion FD2 is separated from the capacities of the floating diffusions FD1 and FDm. When signals of the first photoelectric conversion units PD3L and PD4L and the second photoelectric conversion units PD3R and PD4R are detected, the division transistor TRdiv1 is turned off, and the division transistor TRdiv2 is turned on, so that the capacity of the floating diffusion FD1 is separated from the capacities of the floating diffusions FD2 and FDm.

The remaining operations are similar to the fourth read operation of FIG. 7, and thus it is possible to obtain the pixel signals S1L to S4L and S1R to S4R of the signal level and the pixel signals R1L to R4L and R1R to R4R of the black level.

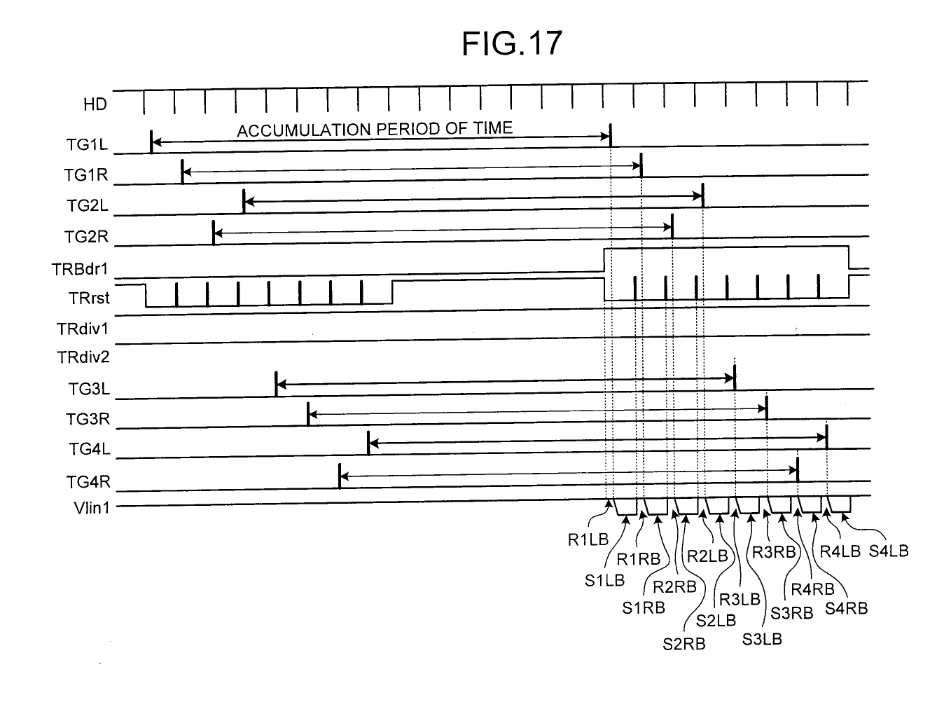

FIG. 17 is a timing chart illustrating voltage waveforms of the respective components when the pixel of FIG. 12 performs a fifth read operation.

In the fourth read operation of FIG. 16, when signals of the first photoelectric conversion units PD1L and PD2L and the second photoelectric conversion units PD1R and PD2R are detected, the capacity of the floating diffusion FD2 is separated from the capacities of the floating diffusions FD1 and FDm, and when signals of the first photoelectric conversion units PD3L and PD4L and the second photoelectric conversion units PD3R and PD4R are detected, the capacity of the floating diffusion FD1 is separated from the capacities of the floating diffusions FD2 and FDm. On the other hand, in the fifth read operation of FIG. 17, as the division transistors TRdiv1 and TRdiv2 is turned on, the capacities of the floating diffusions FD1, FD2, and FDm are combined. The remaining operations are similar to the fourth read operation of FIG. 16, and thus it is possible to reduce the conversion gain to be smaller than that of the method of FIG. 16 and obtain the pixel signals S1LB to S4LB and S1RB to S4RB of the signal level and the pixel signals R1LB to R4LB, R1RB to R4RB of the black level.

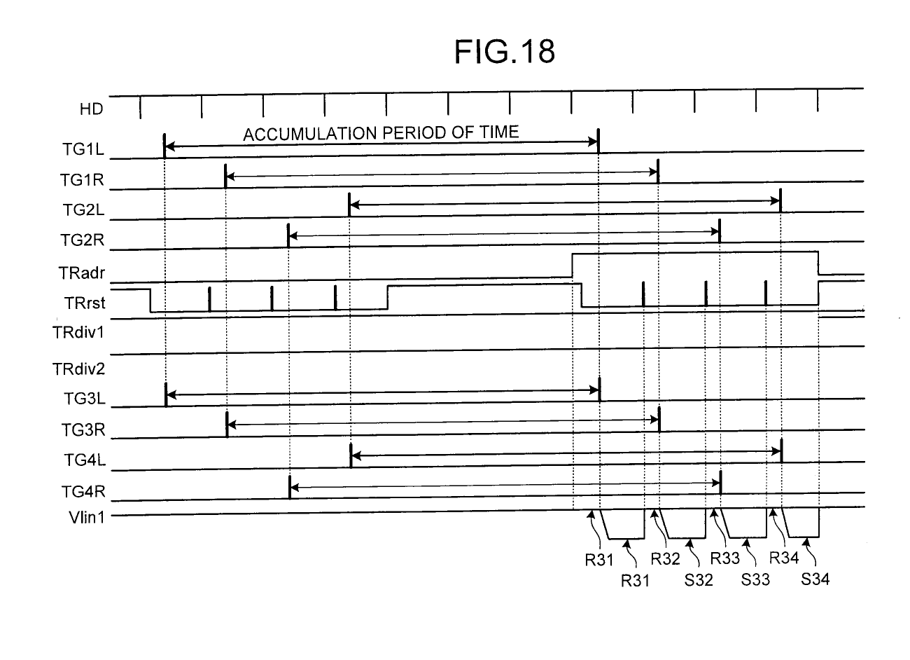

FIG. 18 is a timing chart illustrating voltage waveforms of the respective components when the pixel of FIG. 12 performs a sixth read operation.

In the fifth read operation of FIG. 8, as the switching transistor TRmix is turned on, the capacities of the floating diffusions FD1 and FD2 are combined. On the other hand, in the sixth read operation of FIG. 18, as the division transistors TRdiv1 and TRdiv2 are turned on, the capacities of the floating diffusions FD1, FD2, and FDm are combined.

The remaining operations are similar to the fifth read operation of FIG. 8, and thus it is possible to obtain the pixel signals S31 to S34 of the signal level and the pixel signals R31 to R34 of the black level.

In the methods of FIGS. 13 and 16, in order to increase the conversion gain, when signals of the first photoelectric conversion units PD1L and PD2L and the second photoelectric conversion units PD1R and PD2R are detected, the capacity of the floating diffusion FD2 is separated from the capacities of the floating diffusions FD1 and FDm, and when signals of the first photoelectric conversion units PD3L and PD4L and the second photoelectric conversion units PD3R and PD4R are detected, the capacity of the floating diffusion FD1 is separated from the capacities of the floating diffusions FD2 and FDm.

In order to further increase the conversion gain, when signals of the first photoelectric conversion units PD1L, PD2L, PD3L, and PD4L and the second photoelectric conversion units PD1R, PD2R, PD3R, and PD4R are detected, the capacities of the floating diffusions FD1 and FD2 may be separated from the capacity of the floating diffusion FDm.

At this time, it is possible to separate the capacity of the floating diffusion FDm from the capacities of the floating diffusions FD1 and FD2 by setting the potential of the floating diffusion FDm to be deeper than the potentials of the floating diffusions FD1 and FD2. In order to set the potential of the floating diffusion FDm to be deeper than the potentials of the floating diffusions FD1 and FD2, it is preferable to turning on the reset transistor TRrst in a state in which the power potential VRD is at the high level so that the potential of the floating diffusion FDm is deeper and then setting the gate potentials of the division transistors TRdiv1 and TRdiv2 to an intermediate potential between the low level and the high level in a state in which the reset transistor TRrst is turned off.

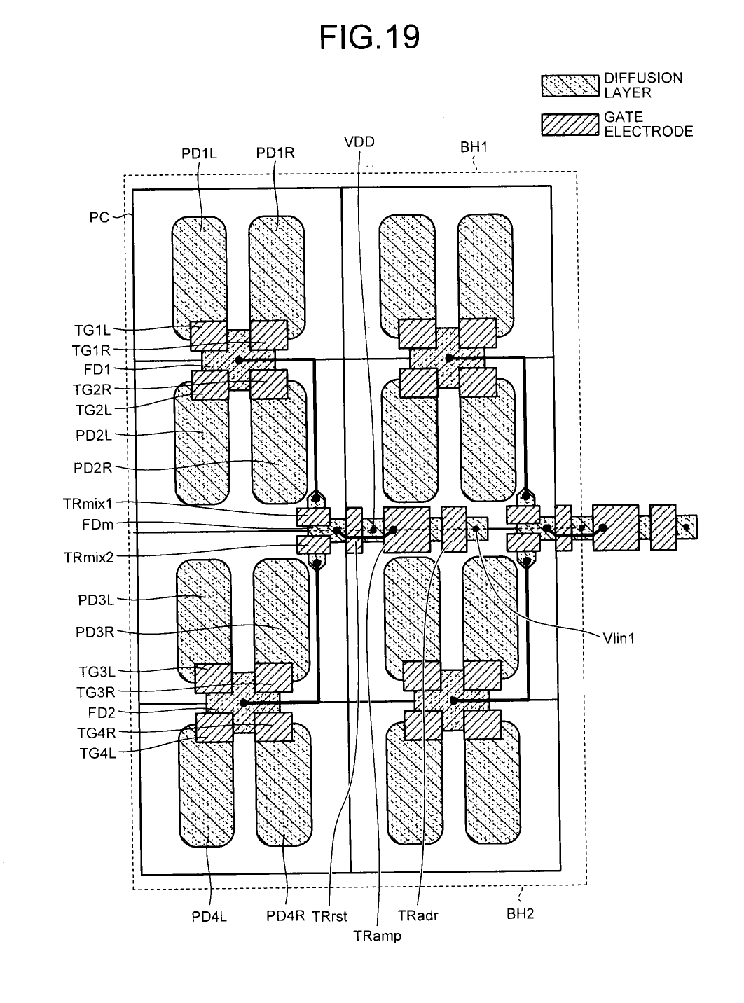

FIG. 19 is a plane view illustrating an exemplary layout configuration of the pixel of FIG. 12.

Referring to FIG. 19, in a first column, the photoelectric conversion units PD1L and PD1R are arranged in a first row to be adjacent in the row direction RD, the photoelectric conversion units PD2L and PD2R are arranged in a second row to be adjacent in the row direction RD, the photoelectric conversion units PD3L and PD3R are arranged in a third row to be adjacent in the row direction RD, and the photoelectric conversion units PD4L and PD4R are arranged in a fourth row to be adjacent in the row direction RD. The same applies to a second column. The photoelectric conversion units PD1L, PD1R, PD2L, and PD2R in the first column and the second column are disposed in the Bayer array BH1. The photoelectric conversion units PD3L, PD3R, PD4L, and PD4R in the first column and the second column are disposed in the Bayer array BH2. The floating diffusion FD1 is arranged among the photoelectric conversion units PD1L, PD1R, PD2L, and PD2R, the floating diffusion FD2 is arranged among the photoelectric conversion units PD3L, PD3R, PD4L, and PD4R, and the floating diffusion FDm is arranged between the photoelectric conversion units PD2L and PD2R and the photoelectric conversion units PD3L and PD3R.

The read transistor TG1L is arranged between the photoelectric conversion unit PD1L and the floating diffusion FD1, the read transistor TG1R is arranged between the photoelectric conversion unit PD1R and the floating diffusion FD1, the read transistor TG2L is arranged between the photoelectric conversion unit PD2L and the floating diffusion FD1, and the read transistor TG2R is arranged between the photoelectric conversion unit PD2R and the floating diffusion FD1. The read transistor TG3L is arranged between the photoelectric conversion unit PD3L and the floating diffusion FD2, the read transistor TG3R is arranged between the photoelectric conversion unit PD3R and the floating diffusion FD2, the read transistor TG4L is arranged between the photoelectric conversion unit PD4L and the floating diffusion FD2, and the read transistor TG4R is arranged between the photoelectric conversion unit PD4R and the floating diffusion FD2.

Between the Bayer arrays BH1 and BH2, the division transistors TRdiv1 and TRdiv2 are arranged to be adjacent in the column direction CD. The reset transistor TRrst is arranged to be adjacent to the division transistors TRdiv1 and TRdiv2 in the row direction RD, the amplifying transistor TRamp is arranged to be adjacent to the reset transistor TRrst in the row direction RD, and the selecting transistor TRadr is arranged to be adjacent to the amplifying transistor TRamp in the row direction RD.

As a result, it is possible to arrange the division transistors TRdiv1 and TRdiv2 to be adjacent in the column direction CD without undermining the uniform pixel arrangement of the Bayer arrays BH1 and BH2. Thus, it is possible to reduce the capacity of the floating diffusion FDm, and it is possible to improve the conversion gain by separating the capacities of the floating diffusions FD1 from FD2 and the capacity of the floating diffusion FDm and detecting signals.

### Fifth Embodiment

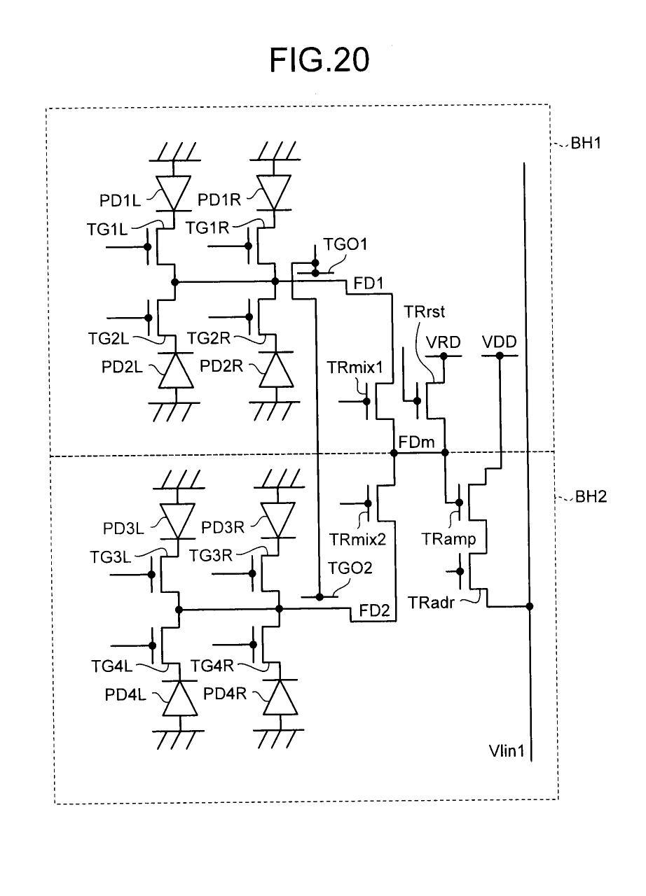

FIG. 20 is a circuit diagram illustrating an exemplary pixel configuration of 1×4 pixels in a 2-pixel 1-cell configuration of a solid-state imaging device according to a fifth embodiment.

Referring to FIG. 20, in the solid-state imaging device, transfer transistors TGO1 and TGO2 are added to the configuration of FIG. 12. The read transistors TG1L, TG1R, TG2L, and TG2R are connected to the floating diffusion FD1 via the transfer transistor TGO1. The read transistors TG3L, TG3R, TG4L, and TG4R are connected to the floating diffusion FD2 via the transfer transistor TGO2.

An operation of the solid-state imaging device of FIG. 20 is similar to those of FIGS. 13 to 18. Here, when charges are read through the read transistors TG1L, TG1R, TG2L, TG2R, TG3L, TG3R, TG4L, and TG4R, the gate potentials of the transfer transistors TGO1 and TGO2 can be set to the intermediate potential between the low level and the high level. Thus, when the charges are read through the read transistors TG1L, TG1R, TG2L, TG2R, TG3L, TG3R, TG4L, and TG4R, even when the read transistors TG1L, TG1R, TG2L, TG2R, TG3L, TG3R, TG4L, and TG4R are caused to perform a pulse operation, it is possible to reduce a variation in the residual charges of the floating diffusions FD1 and FD2 and thus reduce random noise.

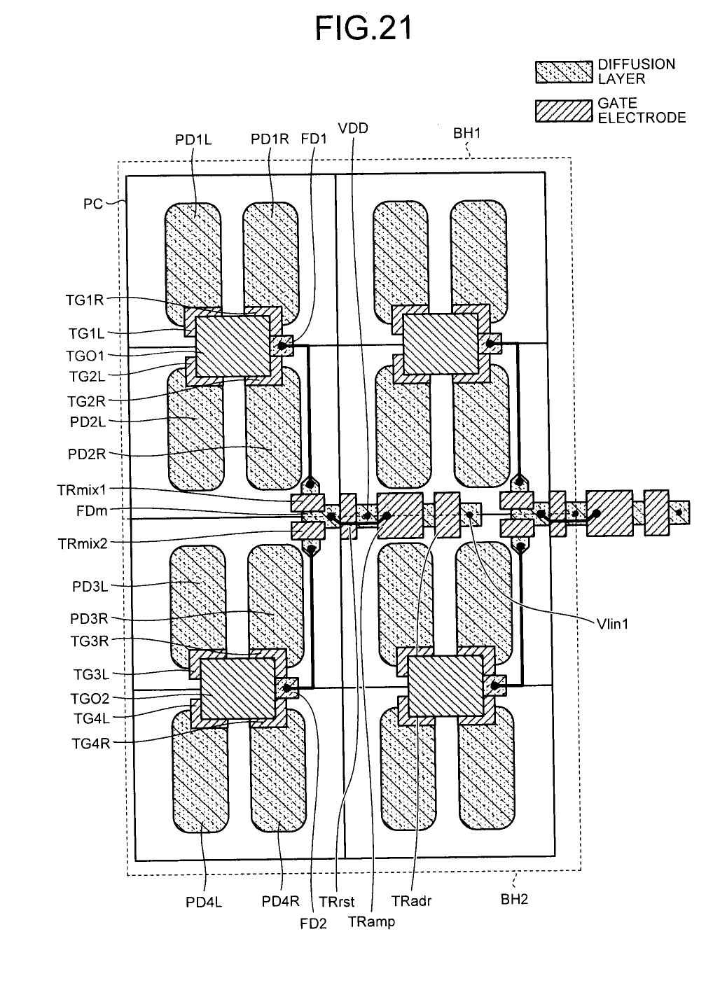

FIG. 21 is a plane view illustrating an exemplary layout configuration of the pixel of FIG. 20.

In the configuration of FIG. 21, with respect to FIG. 19, the transfer transistor TGO1 is arranged among the read transistors TG1L, TG1R, TG2L, and TG2R, and the transfer transistor TGO2 is arranged among the read transistors TG3L, TG3R, TG4L, and TG4R. The floating diffusion FD1 is arranged to be adjacent to the transfer transistor TGO1 in the row direction RD, and the floating diffusion FD2 is arranged to be adjacent to the transfer transistor TGO2 in the row direction RD. Thus, it is possible to arrange the division transistors TRdiv1 and TRdiv2 and the transfer transistors TGO1 and TGO2 without undermining the uniform pixel arrangement of the Bayer arrays BH1 and BH2.

### Sixth Embodiment

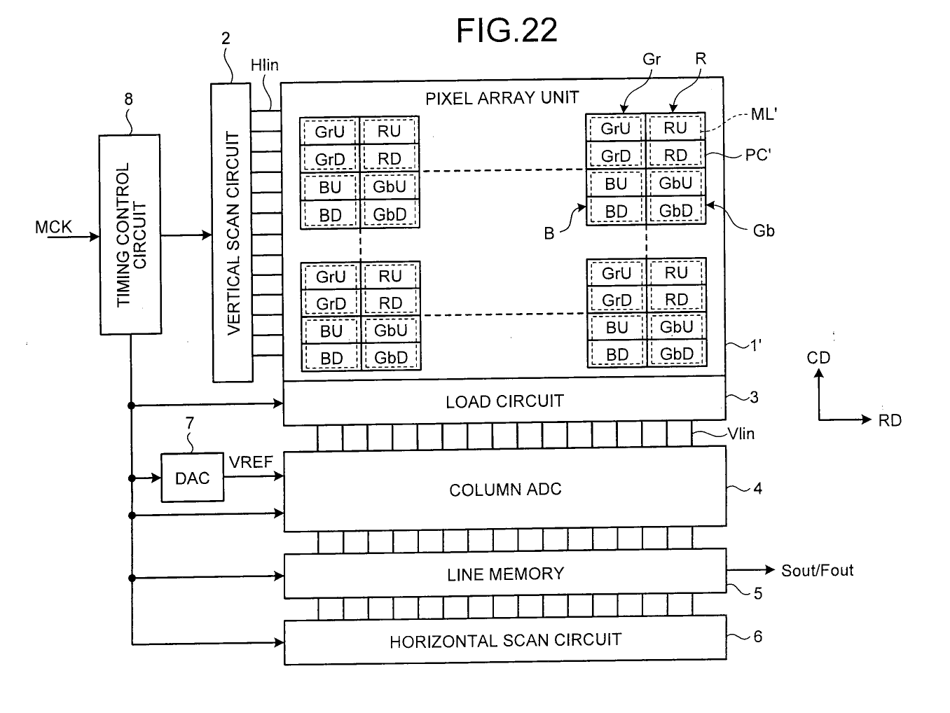

FIG. 22 is a block diagram illustrating a schematic configuration of a solid-state imaging device according to a sixth embodiment.

In the solid-state imaging device, a pixel array unit 1′ is disposed instead of the pixel array unit 1 of FIG. 1. In the pixel array unit 1′, pixels PC′ are disposed instead of the pixels PC of FIG. 1. The pixels PC′ may configure a Bayer array including two green pixels Gr and Gb, one red pixel R, and one blue pixel B.

Here, each of the pixels PC′ is provided with a first photoelectric conversion unit and a second photoelectric conversion unit that are arranged to be adjacent in a column direction CD. A photo diode may be used as the photoelectric conversion unit. For example, in the Bayer array, the photoelectric conversion units GrU and GrD are disposed for the green pixel Gr, the photoelectric conversion units RU and RD are disposed for the red pixel R, the photoelectric conversion units BU and BD are disposed for the blue pixel B, and the photoelectric conversion units GbU and GbD are disposed for the green pixel Gb. Each of the pixels PC′ is also provided with a micro lens ML′ that is shared by the first photoelectric conversion unit and the second photoelectric conversion unit. The solid-state imaging device may operate, similarly to the solid-state imaging device of FIG. 1.

### Seventh Embodiment

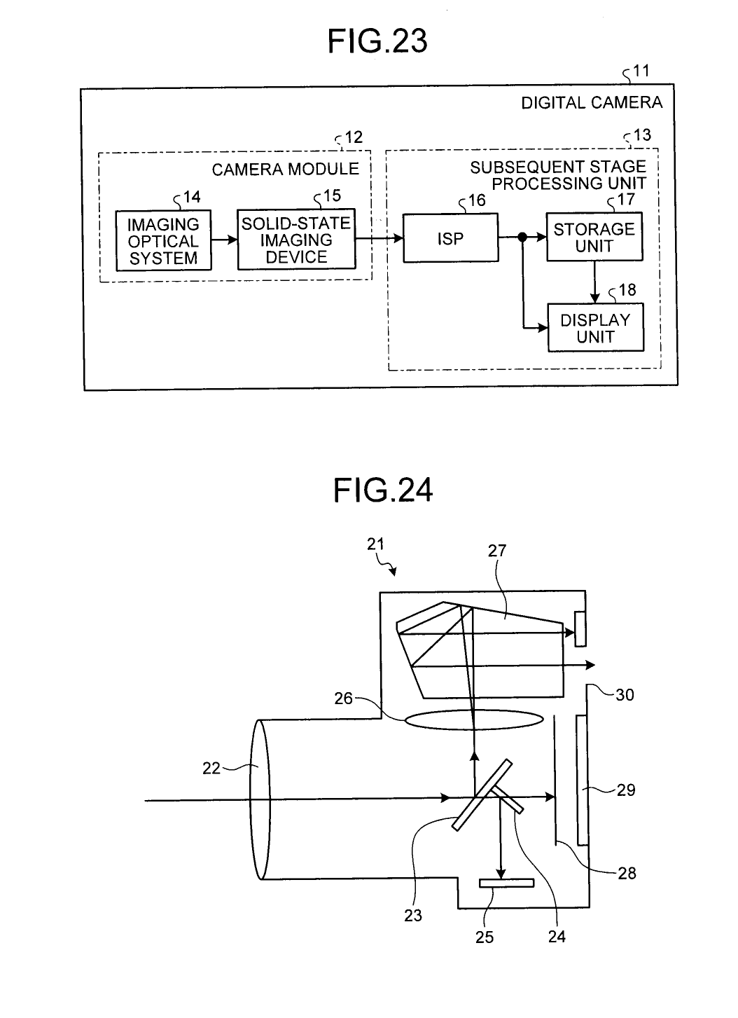

FIG. 23 is a block diagram illustrating a schematic configuration of a digital camera to which a solid-state imaging device is applied according to a seventh embodiment.

Referring to FIG. 23, a digital camera 11 includes a camera module 12 and a subsequent stage processing unit 13. The camera module 12 includes an imaging optical system 14 and a solid-state imaging device 15. The subsequent stage processing unit 13 includes an image signal processor (ISP) 16, a storage unit 17, and a display unit 18. At least a part of the ISP 16 may be integrated into one chip together with the solid-state imaging device 15. As the solid-state imaging device 15, for example, any one configuration of FIG. 1, FIG. 11, FIG. 12, and FIG. 22 may be used.

The imaging optical system 14 acquires light from a subject, and forms a subject image. The solid-state imaging device 15 images a subject image. The ISP 16 performs signal processing on an image signal obtained by the imaging by the solid-state imaging device 15. The storage unit 17 stores an image that has been subjected to the signal processing of the ISP 16. The storage unit 17 outputs the image signal to the display unit 18 according to the user's operation or the like. The display unit 18 displays an image according to the image signal input from the ISP 16 or the storage unit 17. The display unit 18 is, for example, a liquid crystal display. The camera module 12 can be applied to, for example, an electronic device such as a mobile terminal with a camera as well as the digital camera 11.

### Eighth Embodiment

FIG. 24 is a cross-sectional view illustrating a schematic configuration of a camera module to which a solid-state imaging device is applied according to an eighth embodiment.

Referring to FIG. 24, light incident on a lens 22 of a camera module 21 from a subject passes through a main mirror 23, a sub mirror 24, and a mechanical shutter 28 and is then incident on a solid-state imaging device 29.

The light reflected by the sub mirror 24 is incident on an auto focus (AF) sensor 25. The camera module 21 performs a focusing operation based on a detection result of the AF sensor 25. The light reflected by the main mirror 23 passes through a lens 26 and a prism 27 and is then incident on a finder 30.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device, comprising:
a pixel array unit including pixels arranged in a row direction and a column direction, each of the pixels including first and second photoelectric conversion units that are arranged to be adjacent in a certain direction, each of the first and second photoelectric conversion units accumulating charges obtained by photoelectric conversion;
micro lenses each of which is disposed for each pixel; and
a timing control circuit that controls a read timing such that a read order of the first photoelectric conversion units and the second photoelectric conversion units in first and second lines of a same color is changed.

2. The solid-state imaging device according to claim 1,
wherein at a time of imaging, signals of the first photoelectric conversion unit and the second photoelectric conversion unit of each of the pixels are simultaneously read, and
at a time of focusing, signals of the first photoelectric conversion unit and the second photoelectric conversion unit of each of the pixels are separately read.

3. The solid-state imaging device according to claim 1,
wherein the first photoelectric conversion unit and the second photoelectric conversion unit are adjacent in the column direction.

4. The solid-state imaging device according to claim 1,
wherein the first photoelectric conversion unit and the second photoelectric conversion unit are adjacent in the row direction.

5. A solid-state imaging device, comprising:
a pixel array unit including pixels arranged in a row direction and a column direction, each of the pixels including first and second photoelectric conversion units that are arranged to be adjacent in a certain direction, each of the first and second photoelectric conversion units accumulating charges obtained by photoelectric conversion;
micro lenses each of which is disposed for each pixel and shared by the first and second photoelectric conversion units;
a voltage converting unit that converts signal charges read from the first photoelectric conversion unit or the second photoelectric conversion unit into a voltage; and
a conversion capacity switching unit that changes a conversion capacity of the voltage converting unit.

6. The solid-state imaging device according to claim 5,
wherein the conversion capacity switching unit includes a switching transistor that connects the voltage converting units that are adjacent in the column direction.

7. The solid-state imaging device according to claim 6,
wherein the two switching transistors are connected in series between the voltage converting units of the neighboring pixels.

8. The solid-state imaging device according to claim 6,
wherein the voltage converting unit includes
a first voltage converting unit that is shared by first and second photoelectric conversion units of a first pixel and third and fourth photoelectric conversion units of a second pixel and
a second voltage converting unit that is shared by fifth and sixth photoelectric conversion units of a third pixel and seventh and eighth photoelectric conversion units of a fourth pixel, and
the switching transistor includes a first switching transistor that connects the first voltage converting unit with the second voltage converting unit.

9. The solid-state imaging device according to claim 5,
wherein the conversion capacity switching unit includes a division transistor that divides the voltage converting unit that converts the charges generated by the pixel into a voltage into a first voltage converting unit and a second voltage converting unit.

10. The solid-state imaging device according to claim 5,
wherein each of the pixels includes
a first read transistor that reads the signal charges generated by the first photoelectric conversion unit out to the voltage converting unit,
a second read transistor that reads the signal charges generated by the second photoelectric conversion unit out to the voltage converting unit,
an amplifying transistor that amplifies the signal voltage converted by the voltage converting unit, and
a reset transistor that resets the voltage converting unit, and
the division transistor divides the voltage converting unit into the first voltage converting unit at the read transistor side and the second voltage converting unit at the amplifying transistor side.

11. The solid-state imaging device according to claim 10,
wherein the first photoelectric conversion unit is connected to the first voltage converting unit via the first read transistor,
the second photoelectric conversion unit is connected to the first voltage converting unit via the second read transistor,
the first read transistor is connected to a gate of the amplifying transistor via the division transistor, and
the second read transistor is connected to the gate of the amplifying transistor via the division transistor.

12. The solid-state imaging device according to claim 11,
wherein the reset transistor is connected to the second voltage converting unit.

13. The solid-state imaging device according to claim 12, further comprising,
a row selecting transistor that is connected to the amplifying transistor in series.

14. The solid-state imaging device according to claim 10,
wherein the amplifying transistor and the voltage converting unit are shared by a first pixel, a second pixel, a third pixel, and a fourth pixel that are sequentially arranged in the column direction,
the first pixel includes
a first photoelectric conversion unit that generates charges by photoelectric conversion,
a second photoelectric conversion unit that generates charges by photoelectric conversion,
a first read transistor that reads the charges generated by the first photoelectric conversion unit out to the voltage converting unit, and
a second read transistor that reads the charges generated by the second photoelectric conversion unit out to the voltage converting unit,
the second pixel includes
a third photoelectric conversion unit that generates charges by photoelectric conversion,
a fourth photoelectric conversion unit that generates charges by photoelectric conversion,
a third read transistor that reads the charges generated by the third photoelectric conversion unit out to the voltage converting unit, and
a fourth read transistor that reads the charges generated by the fourth photoelectric conversion unit out to the voltage converting unit,
the third pixel includes
a fifth photoelectric conversion unit that generates charges by photoelectric conversion,
a sixth photoelectric conversion unit that generates charges by photoelectric conversion,
a fifth read transistor that reads the charges generated by the fifth photoelectric conversion unit out to the voltage converting unit, and
a sixth read transistor that reads the charges generated by the sixth photoelectric conversion unit out to the voltage converting unit,
the fourth pixel includes
a seventh photoelectric conversion unit that generates charges by photoelectric conversion,
an eighth photoelectric conversion unit that generates charges by photoelectric conversion,
a seventh read transistor that reads the charges generated by the seventh photoelectric conversion unit out to the voltage converting unit, and
an eighth read transistor that reads the charges generated by the eighth photoelectric conversion unit out to the voltage converting unit, and
the division transistor includes
a first division transistor that divides the voltage converting unit into a third voltage converting unit at the first to fourth read transistors sides and the second voltage converting unit, and
a second division transistor that divides the voltage converting unit into a fourth voltage converting unit at the fifth to eighth read transistors side and the second voltage converting unit.

15. The solid-state imaging device according to claim 14,
wherein the second voltage converting unit is arranged between the second pixel and the third pixel, the third voltage converting unit is arranged between the first pixel and the second pixel, and the fourth voltage converting unit is arranged between the third pixel and the fourth pixel.

16. The solid-state imaging device according to claim 15,
wherein the first division transistor and the second division transistor are arranged to be adjacent in the column direction between the second pixel and the third pixel.

17. The solid-state imaging device according to claim 16,
wherein the division transistor, the amplifying transistor, and the reset transistor are arranged to be adjacent in the row direction between the second pixel and the third pixel.

18. The solid-state imaging device according to claim 5,
wherein the conversion capacity switching unit sets a small capacity to the voltage converting unit at a time of a low luminance shooting operation, and sets a large capacity to the voltage converting unit at a time of a high luminance shooting operation.

19. The solid-state imaging device according to claim 5, further comprising,
a timing control circuit that controls a read timing such that a read order of the first photoelectric conversion units and the second photoelectric conversion units in first and second lines of a same color is changed.

20. The solid-state imaging device according to claim 19,
wherein at a time of imaging, signals of the first photoelectric conversion unit and the second photoelectric conversion unit of each of the pixels are simultaneously read, and
at a time of focusing, signals of the first photoelectric conversion unit and the second photoelectric conversion unit of each of the pixels are separately read.
